(19) United States
(12) Patent Application Publication
(10) Pub. No.: US 2025/0085147 A1
(43) Pub. Date: Mar. 13, 2025

(54) OUT OF PRODUCT SENSOR

(71) Applicant: Ecolab USA Inc., Saint Paul, MN (US)

(72) Inventors: Eugene Tokhtuev, Woodbury, MN (US); Anatoly Skirda, Eagan, MN (US); Michael Patrick Kremer, Rosemount, MN (US); Rachel McGinness, Rosemount, MN (US); Lawrence Salvati, Stillwater, MN (US)

(21) Appl. No.: 18/830,421

(22) Filed: Sep. 10, 2024

Related U.S. Application Data
(60) Provisional application No. 63/581,853, filed on Sep. 11, 2023.

(51) Int. Cl. G01F 1/69; G01F 1/684; G01F 1/696; G08B 21/18

(52) U.S. Cl. CPC G01F 1/69; G01F 1/6842; G01F 1/6847; G01F 1/696; G08B 21/182

(57) ABSTRACT

Out of product sensors can include a housing having a first surface and defining a flow channel. A circuit board can be coupled to the first surface of the housing and support a thermistor bridge. The thermistor bridge can be arranged so that some thermistors are in a first sensing area and other thermistors are in a second sensing area. The housing can be configured such that thermal resistance between the flow channel and the first sensing area is lower than thermal resistance between the flow channel and the second sensing area, and/or fluid flowing in the flow channel is directed more toward the first sensing area than the second sensing area. Liquid in the flow channel can affect thermal behavior of thermistors in the first and second sensing area differently and can be used to determine whether liquid is flowing through the sensor.

### CROSS-REFERENCE TO RELATED APPLICATION

This application claims the benefit of U.S. Provisional Application No. 63/581,853, filed Sep. 11, 2023, the content of which is hereby incorporated by reference in its entirety.

### BACKGROUND

Fluid dispensing systems typically deliver quantities of fluid to one or more components within the system. In certain fields, fluid dispensing systems may deliver small quantities of fluid. For example, in the medical field, a fluid dispensing system may be used to deliver small quantities of fluid into a patient's vascular system. However, in certain other fields, fluid dispensing systems may deliver larger quantities of fluid. For example, in a large-scale hotel or other laundry or restaurant facility, a fluid dispensing system may need to deliver large quantities of detergent, rinse agent, bleach or other cleaning agents on a continual basis.

In fluid delivery systems where large quantities of fluid are delivered, the fluid can be supplied automatically. In such systems, the supply source (such as a bottle) and fluid delivery line (such as a supply tube) are frequently integrated with the device to which the fluid is delivered, such as a warewasher or a laundry machine. This makes it more difficult for the operator to check on the remaining amount of the fluid remaining in the supply source and often results in the system running out of fluid during, for example, a cleaning cycle.

### SUMMARY

Various aspects of the disclosure relate to out of product (OOP) sensors. Existing out-of-product sensors typically detect the absence of fluid in the sensor, indicating when the delivery system is empty (filled with air). However, many products are delivered from compressible bottles, and when the product runs out, the tubing in the delivery system remains filled with fluid. Traditional out-of-product sensors cannot recognize delivery failures when the product is in the tubing but not moving. Some aspects of this disclosure utilize a pulsed mode thermistor excitation in an out of product sensor, which in some examples allows for the detection of three distinctive states: “empty (air),” “product present but no flow,” and “flow of product.” Such improvements over existing systems can be used to identify when product has run out and no longer flows, but remains present in the sensor. Additionally or alternatively, in some out of product sensors that rely on capacitance, viscous liquids that coat the interior of the sensor can affect the sensor readings even when liquid is no longer flowing and even if bulk stagnant liquid is not present.

Additionally or alternatively some OOP sensors not only detect the presence or absence of a product, but also can provide information regarding proper functioning of a liquid delivery system, such as detecting bubbles in a flow line, warning if a corresponding pump is not working, or indicating if liquid delivery tubing is damaged. Various settings and thresholds can be calibrated and customized for a given system in order for the OOP sensor to accurately determine various flow information in view of that system's particular configuration and/or use.

Some OOP sensors according to this disclosure include a housing having a first surface and defining a flow channel. An inlet and an outlet can fluidly connect the flow channel to an exterior of the housing. A circuit board can be coupled to the first surface of the housing and can support a thermistor bridge having a plurality of thermistors.

Thermistors of the thermistor bridge can be located in first and second sensing areas, and the housing of the OOP sensor can be configured such that thermal resistance between the flow channel and the first sensing area is lower than thermal resistance between the flow channel and the second sensing area, and/or fluid flowing in the flow channel is directed more toward the first sensing area than the second sensing area. In some such cases, fluid flowing through the flow channel will have a greater thermal affect on thermistors in the first sensing area than in the second sensing area. The different thermal affects on different thermistors in the thermistor bridge caused by fluid flowing through the flow channel can provide information regarding the presence of fluid flowing through the flow channel.

The thermistor bridge can include a first branch having a first thermistor in series with a second thermistor, with a first point between the first thermistor and the second thermistor, and a second branch having a third thermistor in series with a fourth thermistor, with a second point between the third thermistor and the fourth thermistor. The first branch and the second branch can be arranged in parallel between a powered side of the thermistor bridge and a reference side of the thermistor bridge such that the first thermistor and the third thermistor are coupled to the powered side of the thermistor bridge and the second thermistor and the fourth thermistor are coupled to the reference side of the thermistor bridge.

A controller can be configured to cause current to flow from a power supply to the thermistor bridge for a heating time duration. The controller can measure a thermal behavior of the thermistor bridge to determine a flow status of fluid through the flow channel, such as whether fluid is flowing through, stagnant in, or absent from the flow channel. The controller can provide a plurality of measurement pulses to the thermistor bridge at a measurement frequency, receive a measurement signal value representative of a voltage between the first and second points of the thermistor bridge during each of the measurement pulses, and determine an average measurement signal value. The controller can determine, based on the average measurement signal value, a flow status through the flow channel.

In some cases, determining the flow status within the flow channel comprises, if the average measurement signal value satisfies a first predetermined threshold condition, determining that a fluid is flowing in the flow channel. Additionally or alternatively, in some cases, determining the flow status within the flow channel comprises, if the average measurement signal value satisfies a second predetermined threshold condition, determining that a fluid is not present in the flow channel. The first predetermined threshold condition can include the average measurement signal value being below a first predetermined threshold value and the second predetermined threshold can include the average measurement signal value being above a second predetermined threshold value, the second predetermined threshold value being higher than the first. Determining the flow status can further include, if the average measurement signal value is between the first predetermined threshold value and the second predetermined threshold value, determining that a fluid is present, but not flowing, in the flow channel. Absence of the liquid when expected can indicate an out of product event.

Temperature information can be used to correct for temperature effects on the behavior of the thermistor bridge. The controller can be configured to receive a second signal, which can be representative of a temperature of a fluid in the flow channel. In some examples, the controller can calculate a temperature using the second signal. The second signal can be representative of a voltage drop across a thermistor of the thermistor bridge or a standalone thermistor. The second signal can be used to calculate corrected measurement signal values.

Using differences in the thermal behavior of thermistors in different sensing areas can allow for easy distinction between flow states in the flow channel, such as times when a liquid is flowing through the flow channel of the sensor, when the liquid is not present in the flow channel, or where liquid is stagnant within the flow channel. Temperature measurements can be used to correct measurement signal values to compensate for temperature effects on thermal behavior.

### BRIEF DESCRIPTION OF THE DRAWINGS

FIG. 1A is a diagram illustrating an example fluid flow system with an out-of-product sensing system that detects presence and/or absence of a product to be dispensed.

FIG. 1B is a diagram illustrating another example system that dispenses multiple products.

FIG. 2 shows an example schematic diagram of aspects of an out of product sensing system.

FIG. 3 shows a side view of an example configuration of an out of product sensor.

FIG. 4A shows an example cross-sectional view of an embodiment of an out of product sensor.

FIG. 4B shows a perspective exploded view of the out of product sensor of FIG. 4A

FIG. 4C shows another perspective exploded view of the out of product sensor of FIG. 4A.

FIG. 5A shows an example cross-sectional view of an embodiment of an out of product sensor.

FIG. 5B shows a perspective exploded view of the out of product sensor of FIG. 5A

FIG. 5C shows another perspective exploded view of the out of product sensor of FIG. 5A.

FIG. 6A shows an example cross-sectional view of an embodiment of an out of product sensor.

FIG. 6B shows a perspective exploded view of the out of product sensor of FIG. 6A

FIG. 6C shows another perspective exploded view of the out of product sensor of FIG. 6A.

FIG. 7 shows an example cross-sectional view of an embodiment of an out of product sensor.

FIG. 8 shows an example out of product sensor.

FIG. 9 is an example voltage vs. time plot showing a voltage in an out of product sensing system.

FIG. 10 shows an example plot of average measurement signal values over time in an out of product sensing system.

FIG. 11 shows example current pulses through the thermistor bridge for an example embodiment.

FIG. 12 shows example readings measured at the input 7a and example corresponding flow status indications based on the readings.

FIG. 13 shows an example plot of a measurement signal in various flow states as a function of temperature.

FIG. 14 shows an example plot of raw and corrected sensor readings over a range of different temperatures at a constant flow rate.

FIG. 15 shows corrected sensor readings over a range of temperatures for different flow statuses over a range of different temperatures.

FIG. 16 shows an alternative example schematic diagram of aspects of an out of product sensing system including a standalone thermistor

FIG. 17A shows an example cross-sectional view of an embodiment of an OOP sensor including a standalone thermistor in addition to a thermistor bridge.

FIG. 17B shows a perspective exploded view of the OOP sensor of FIG. 17A

FIG. 17C shows another perspective exploded view of the out of product sensor of FIG. 17A.

FIG. 17D shows an example heat sink proximate a pair of thermistors.

FIG. 18A shows an example plot of a measurement signal as a function of measurement frequency during a constant fluid flow through an OOP sensor.

FIG. 18B shows an example relationship of the measurement frequency needed to maintain a constant measurement signal as a function of temperature.

FIG. 19 shows an example measurement signal for a constant fluid flow through an OOP sensor as a function of temperature for a constant measurement frequency and a measurement frequency changing linearly with the temperature.

FIG. 20 shows an example plot of a measurement signal over time that can be used to detect bubbles in the OOP sensor.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Examples of constructions, materials, dimensions, and manufacturing processes are provided for selected elements, and all other elements employ that which is known to those of ordinary skill in the field of the disclosure. Those skilled in the art will recognize that many of the noted examples have a variety of suitable alternatives.

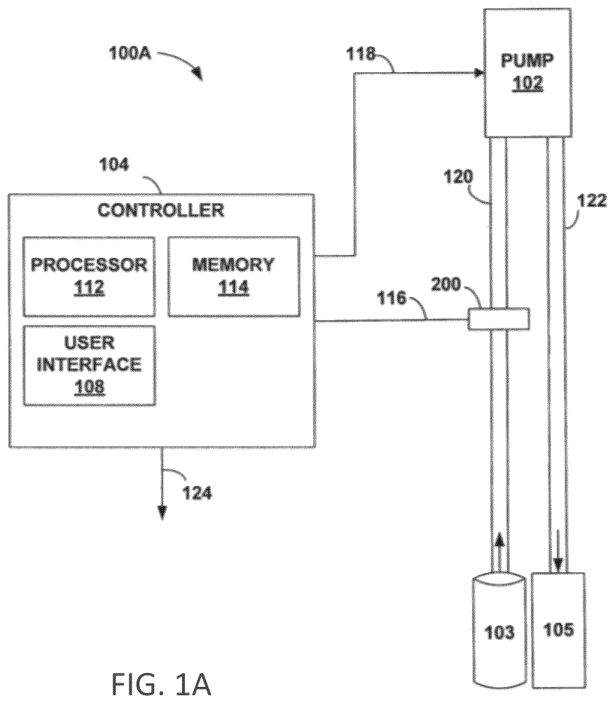

FIG. 1A is a diagram illustrating an example fluid flow system with an out-of-product sensing system that detects presence and/or absence of a product to be dispensed. The system 100A includes controller 104, pump 102 and product reservoir 103. Pump 102 draws the product (e.g., a liquid product) from reservoir 103 and delivers the product to dispensing site 105. Pump 102 draws product from product reservoir 103 through an input fluid delivery line 120 and supplies fluid to dispensing site 105 via an output fluid delivery line 122. Product reservoir 103 may contain any one of a multitude of different types of products having varying degrees of transparency and/or turbidity. In some embodiments, an out of product (“OOP”) sensor 200 is configured to detect a presence or absence of a fluid flowing, for example, in input fluid delivery line 120 and/or output fluid delivery line 122. In the illustrated examples, OOP sensor 200 is positioned in line with the input fluid delivery line 120, and can be configured to determine, for example, a presence or absence of a fluid (e.g., a liquid) in the line.

Controller 104 can communicate with pump 102 via connection 118. In some examples, pump 102 draws the product from reservoir 103 or stops pumping under the control of Controller 104. In some examples, controller 104 may communicate with dispensing site 105 via another connection (not shown).

In some examples, controller 104 includes processor 112, user interface 108, and memory 114. In some examples, systems can include multiple controllers 104. Signals generated by OOP sensor 200 can be communicated to controller 104 via connection 116. Connection 116 may transmit a digital or analog signal. Connection 116 may include, for example, a standard I2C connection. However, any appropriate connection/communication channel known in the art may be used. Controller 104 can further include at least one external connection 124 such as an internet, telephone, wireless or other connection for achieving external communication.

In some examples, memory 114 stores software for running controller 104 and also stores data that is generated or used by processor 112. In some examples, processor 112 runs software stored in memory 114 to manage operation of controller 104. User interface 108 may be as simple as a few light emitting diodes (LEDs) and/or user actuatable buttons or may include a display, a keyboard or keypad, mouse or other appropriate mechanisms for communicating with a user.

Dispensing site 105 may be an end use location of the product or may be some other intermediate location. For example, when a fluid flow system 100A is used in a commercial laundry or kitchen application, dispensing site 105 may be a washing machine or warewashing machine, in which case the product(s) may be dispensed into an on-unit dispense mechanism or directly into the wash environment. In that example, the product(s) dispensed may include laundry or dish detergent, fabric softener, bleach, sanitizer, rinse agent, etc. As another example, when fluid dispensing system is used in a hotel, business, industrial or other application in which service employees perform cleaning duties, dispensing site 105 may be a bucket, pail or other vessel into which the product(s) are dispensed. Dispensing site 105 may also be a hose or other tubing from which the fluid(s) is directed to a desired location. It shall be understood that an out-of-product sensing system can be used in many different applications in which fluid is dispensed and that the disclosure is not limited in this respect. Examples of applications in which an out-of-product sensing system can be used include laundry applications, dishwashing applications, commercial cleaning operations, food preparation and packaging applications, industrial processes, healthcare applications, vehicle care applications, and others known in the art.

Input fluid delivery line 120 and output fluid delivery line 122 may be implemented using any type of flexible or inflexible tubing, depending upon the application. This tubing may be transparent, translucent, braided or other type of tubing. The tubing may be made of polyethylene, ethylene-vinyl acetate, polytetrafluoroethylene, or any other suitable material. For simplicity and not by limitation, input fluid delivery line 120 and output fluid delivery line can be referred to as “input tubing 120” and “output tubing 122,” respectively. Input tubing 120, output tubing 122 and pump 102 may be referred to herein as a “dispensing channel.” Pump 102 may be any form of pumping mechanism that supplies fluid from product reservoir 103 to dispensing site 105. For example, pump 102 may comprise a peristaltic pump or other form of continuous pump, a positive-displacement pump or other type of pump appropriate for the particular application.

In the example system shown in FIG. 1A, OOP sensor 200 is positioned to detect presence and/or absence of product within input tubing 120. In operation, when fluid dispensing system attempts a dispensing cycle from a product reservoir 103 that has product remaining, input tubing 120 will likewise contain product. In some examples, OOP sensor 200 continuously sends signals to controller 104, and controller 104 interprets those signals to determine product presence or absence within input tubing 120. Over time, as operation continues and more and more product is dispensed, product reservoir 103 becomes substantially empty. Because product is no longer available to dispense, input tubing 120 will likewise become substantially empty. When controller 104 determines that an out-of-product event has occurred based on the signals from OOP sensor 200, controller 104 may generate an out-of-product alert.

In some embodiments, an “out-of-product event” (e.g., an event in which controller 104 detects an absence of fluid within input tubing 120) is determined with respect to one or more predefined out-of-product thresholds. When controller 104 detects an out-of-product event, controller 104 may generate one or more alerts, including a visual and/or audible out-of-product alert (such as text or graphics with without accompanying sound, etc.) displayed on user interface 108. Additionally or alternatively, controller 104 may initiate and send an out-of-product message service call (such as via pager, e-mail, text message, etc.) to a technical service provider via external connection 124.

When an alert is activated to indicate an out-of-product event, a user (such as an employee or service technician) may manually refill product reservoir 103. In this embodiment, the user may temporarily halt or shutdown operation of the fluid flow system before refilling product reservoir 103. In one example, the user may do this by entering commands into controller 104 to stop operation of pump 102 and/or dispensing site 105. In another example, the user may do this by entering control commands via user interface 108 of controller 104 to silence audible and/or visual alerts for a period of time. In another example, the user may do this by entering control commands via user interface 108 of controller 104 to stop operation of pump 102 and/or dispensing site 105. In another example, the user may manually shut off pump 102 and/or dispensing site 105. After the user has refilled product reservoir 103, the user may manually re-start pump 102 and/or dispensing site 105, may enter control commands into controller 104 to restart pump 102 and/or dispensing site 105, or may enter control commands via user interface 108 to cause controller 104 to send control signals (e.g., via connection 118) to re-start pump 102 and/or dispensing site 105. Controller 104 may further re-set, or clear, alerts at the appropriate time (for example, after being manually cleared by a user, after product reservoir 103 has been refilled or system is restarted).

In response to an out-of-product event, controller 104 can automatically stop pump 102 and/or dispensing site 105 when an out-of-product event is detected and/or automatically stop dispensing site 105. In one example, controller 104 may send control signals to pump 102 and/or dispensing site 105 to temporarily stop operation of the corresponding components without user intervention. Controller 104 may then re-start pump 102 and/or dispensing site 105 after receiving input from the user that product reservoir 103 has been re-filled. In another example, controller 104 can temporarily stop pump 102 and/or dispensing site 105 without user intervention. System controller can then send signals to re-start pump 102 and/or dispensing site 105 after receiving input from the user that product reservoir 103 has been re-filled.

OOP sensor 200 or controller 104 may also generate a visual indicator that indicates presence of fluid within input tubing 120. For example, a light of one color, such as green, may be used to indicate that a fluid is flowing through the OOP sensor 200, indicating that product reservoir 103 has product remaining, while a light of another color, such as red or blinking, may be used to indicate that fluid is not flowing through OOP sensor 200, indicating that product reservoir 103 is empty and needs to be refilled.

FIG. 1B is a diagram illustrating another example system that dispenses multiple products. To that end, system 100B includes multiple product channels (A-N), each having associated product reservoirs 103A-103N, pumps 102A-102N, controller 104 and dispensing sites 105A-105N. Pumps 102A-102N are included in pump assembly 101. Pumps 102A-102N draw in fluid from a respective product reservoir 103A-103N through an input tubing 120A-120N, and supply fluid to one of dispensing sites 105A-105N through output tubing 122A-122N. Each product reservoir 103A-103N may contain any of a multitude of different types of products. OOP sensors 200A-200N detect presence and/or absence of the product dispensed in the respective each dispensing channel.

Although the system 100B shown in FIG. 1B shows each dispensing channel as having its own dedicated product reservoir 103, input tubing 120, output tubing 122, pump 102, destination site 105 and OOP sensor 200, it shall be understood that there need not be a one to one correspondence for each dispensing channel. For example, sensors 200A-200N may be implemented in a single unit through which the input tubing for each dispensing channel is routed. Alternatively, various combinations of one channel per sensor or two or more channels per sensors may also be used and the disclosure is not limited in this respect.

Likewise, the example pump assembly 101 of FIG. 1B includes multiple pumps 102A-102N, one for each dispensed product. It shall be understood, however, that there need not be a one to one correspondence between pumps 102A-102N and the dispensing channels. For example, some dispensed products may share one or more pumps, which are switched from one dispensed product to another under control of controller 104. The pump or pumps 102A-102N provide fluid to the appropriate dispensing site 105A-105N from one of product reservoirs 103A-103N.

It shall also be understood that any of sensors 200A-200N may also be positioned to detect presence and/or absence of product within output tubing 122A-122N rather than input tubing 120A-120N as shown in FIG. 1B, and that, in some cases, the location of sensors 200A-200N may be more a matter of convenience than of system performance.

In some examples, controller 104 can be coupled to pump assembly 101 via connection 118. Through connection 118, controller 104 is able to communicate with pump assembly 101 to effectively control operation of each individual pump 102 (e.g., to temporarily stop or start operation, as described previously in reference to FIG. 1A). Depending upon the application, controller 104 may also communicate with one or more dispensing sites 105A-105N.

Each OOP sensor 200A-200N detects presence and/or absence of fluid within the corresponding input tubing 120A-120N. Controller 104 is coupled to each sensor 200A-200N via a corresponding connection 116A-116N. Controller 104 monitors the signals received from each OOP sensor 200A-200N, and may respond as described above to any detected out-of-product events. For example, controller 104 may generate a visual or audible alert or display a message on user interface 108 if system controller detects one or more out-of-product events. The visual or audible alert and/or message displayed on user interface 108 and/or message sent via pager, e-mail or text message, etc. would indicate which of product reservoirs 103A-103N is empty, thus informing a user which product reservoir needs to be filled. In some examples, controller 104 may also automatically temporarily stop and then re-start the pump 102A-102N corresponding to the empty product reservoir 103A-103N and/or may initiate an automatic refill cycle of the empty product reservoir as described above. In other examples, pumps 102A-102N and/or dispensing sites 105A-105N may be stopped and re-started automatically or manually, with or without communication from controller as described with respect to FIG. 1A above.

Although in FIG. 1B each sensor assembly is shown with a dedicated connection to controller 104, it shall be understood that sensors 200A-200N may be connected to communicate with controller 104 in any of several different ways. For example, sensors 200A-200N may be connected to controller 104 in a daisy-chain fashion. In this example, controller 104 is coupled directly to a first OOP sensor 200A via connection 116A and each subsequent OOP sensor 200B-200N is coupled the next sensor assembly, etc. A communication protocol to identify and communicate separately with each OOP sensor 200A-200N may also be used. It shall be understood, however, that this disclosure is not limited with respect to the particular architecture by which sensors 200A-200N are connected with and communicate with controller 104 and that the system may be set up in many different ways known to those of skill in the art.

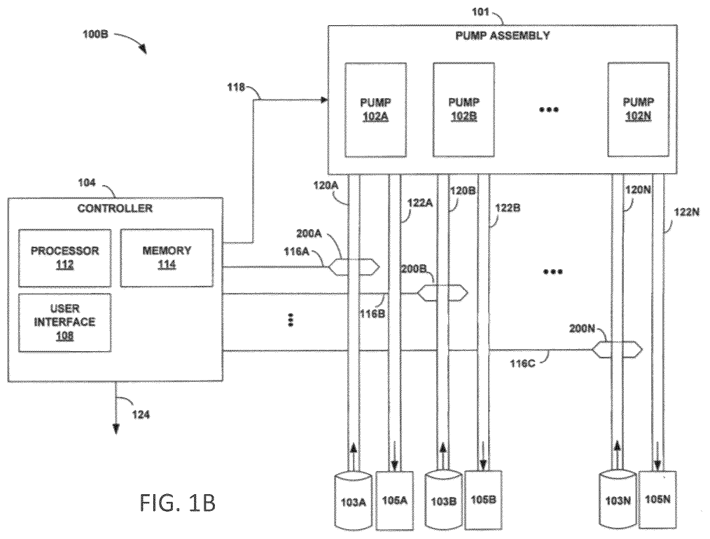

FIG. 2 shows an example schematic diagram of aspects of an out of product sensing system. In the illustrated example, a thermistor bridge 10 comprises a plurality of thermistors, including a first thermistor 1a, a second thermistor 2b, a third thermistor 2a, and a fourth thermistor 1b. In the illustrated example, the thermistor bridge 10 comprises a first branch comprising the first thermistor 1a in series with the second thermistor 2b, with a first point 11 between the first thermistor 1a and the second thermistor 2b. The thermistor bridge 10 of FIG. 2 further comprises a second branch comprising the third thermistor 2a in series with the fourth thermistor 1b, with a second point 12 between the third thermistor 2a and the fourth thermistor 1b. In some examples, as described elsewhere herein, the first thermistor 1a and the fourth thermistor 1b for a first pair of thermistors 21 and the second thermistor 2b and the third thermistor 2a form a second pair of thermistors 22.

As shown, the first branch and the second branch are arranged in parallel between a powered side 15 of the thermistor bridge 10 and a reference side 16 of the thermistor bridge 10. In the illustrated example, the first thermistor 1a and the third thermistor 2a are coupled to the powered side 15 of the thermistor bridge 10 and the second thermistor 2b and the fourth thermistor 1b are coupled to the reference side 16 of the thermistor bridge 10.

The example system of FIG. 2 includes a power supply 6 coupled to the powered side 15 of the thermistor bridge 10 via a switch 4 and a current limiting resistor 3. In some examples, power supply 6 comprises a DC power supply configured to output a DC voltage. In some examples, the power supply 6 is configured to output a constant voltage, such as 5 VDC. In other examples, the power supply 6 can have a controllable output. The reference side 16 of the thermistor bridge 10 is coupled to a reference potential 25, such as a system ground. In various examples, switch 4 can include any type of switch capable of selectively interrupting current flow, such as a mechanical switch or a transistor. During operation, if switch 4 is in an on state, current can flow from the power supply 6 through switch 4 and current limiting resistor 3 to the powered side 15 of the thermistor bridge 10, and through the branches of the thermistor bridge 10 to the reference side 16.

The system of FIG. 2 includes an analog to digital converter (ADC) 7 having a first differential input 7a and a second differential input 7b. In the example of FIG. 2, the first input 7a of ADC 7 comprises inputs coupled to first point 11 and second point 12 of the thermistor bridge 10. Thus, in some examples, first input 7a of ADC 7 is configured to receive a signal representative of the voltage difference between the first point 11 and the second point 12. Additionally, in the example of FIG. 2, the second input 7b of ADC 7 comprises inputs coupled to second point 12 of the thermistor bridge 10 and a reference potential 25. Thus, in some examples, second input 7b of ADC 7 is configured to receive a signal representative of the voltage difference between the second point 12 and a reference voltage.

The system of FIG. 2 includes a controller 5 in communication with the ADC 7, the switch 4, and the power supply 6. In some examples, the controller 5 is configured to receive a measurement signal value representative of a voltage between the first point 11 and the second point 12, for example, from the ADC 7.

Additionally or alternatively, in some embodiments, controller 5 is configured to control operation of switch 4, for example, to control when current is permitted to or prevented from flowing between power supply 6 to thermistor bridge 10. Additionally or alternatively, controller 5 is configured to control operation of power supply 6, for example, enabling/disabling output of power from power supply 6 and/or adjusting an output of power supply 6.

In the illustrated example, controller 5 includes three outputs: a digital output 5a, and analog output 5b, and a logic output 5c. In various examples, controller 5 can include one or more such outputs, but need not necessarily provide all three. In some examples, the controller 5 is configured to provide an output based on information representative of a voltage between the first point 11 and the second point 12 of the thermistor bridge 10, such as, for example, received from ADC 7.

In some examples, controller 5 is in communication with a pump 32, which can be configured to cause fluid to flow through a fluid flow system, such as, for example, pump 102 in FIG. 1A configured to cause fluid to flow from a reservoir 103 to a dispensing site 105. In some examples, pump 32 is configured to cause fluid to flow through an out of product sensor. In some examples, controller 5 is configured to control operation of the pump 32, for example, turning the pump on and off and/or controlling a speed of the pump. In other examples, the controller is configured to receive information from the pump 32, such as an operating state (e.g., on/off) of the pump 32.

In various examples, controller 5 can include a general purpose microprocessor, digital signal processor (DSP), application specific integrated circuit (ASIC), field programmable gate array (FPGA), programmable logic devices (PLDs), or other equivalent logic devices, or combinations of one or more such components. In some examples, functions described herein attributed to a controller can be performed by one or more controllers. In some examples, systems can include multiple controllers distributed throughout a system acting in concert.

In some examples, controller 5 includes or is otherwise in communication with a memory, which can include instructions (e.g., in a non-transitory computer readable medium) for causing the controller to perform one or more functions. In some examples, memory comprises random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media, or combinations of one or more such components.

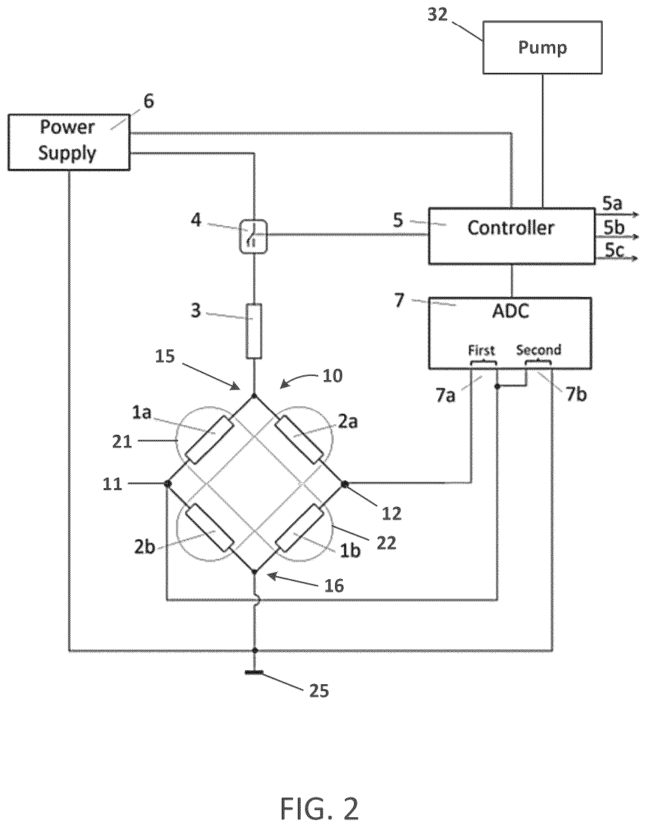

In some embodiments, an OOP sensor for use with various components of the OOP system of FIG. 2 comprises a housing defining a flow channel through which a product flows. FIG. 3A shows a side view of an example configuration of an OOP sensor. In the illustrated example, OOP sensor 300 comprises a housing 304 having a first surface 306 and defining a flow channel 308 through which a fluid can flow. The sensor 300 comprises an inlet 310 and an outlet 312, each fluidly connecting the flow channel 308 to an exterior of the housing 304. In some examples, the inlet 310 and outlet 312 are configured to couple to tubing that can carry fluid to and from the sensor 300 such that the fluid flows from a tubing, through the inlet 310, through the flow channel 308, through the outlet 312, and into additional tubing. With reference to FIG. 1, in some examples, tubing can connect inlet 310 and a reservoir (e.g., 103), and additional tubing can connect outlet 312 to a dispensing site (e.g., 105). In some examples, a pump (e.g., 102) can be positioned between such a reservoir (e.g., 103) and inlet 310 and/or between outlet 312 and such a dispensing site (e.g., 105).

The sensor 300 includes a circuit board 320 coupled to the first surface 306 of the housing 304. In some examples, the circuit board 320 supports a thermistor bridge such as the bridge 10 shown in FIG. 2. In some embodiments, fluid flowing through the flow channel 308 (e.g., a liquid product from a product reservoir) thermally interacts with portions of the thermistor bridge supported by the circuit board 320 such that the fluid affects the temperature of one or more thermistors of the thermistor bridge. In some examples, an air gap is provided around thermistors to prevent heat loss from the thermistors to other structures of an OOP sensor.

FIG. 3B shows a top view of the OOP sensor of FIG. 3A. In the example of FIG. 3B, OOP sensor 300 includes an inlet 310 and an outlet 312, such as described with respect to FIG. 3A. The OOP sensor comprises a circuit board 320 supported by a first surface of the housing of the OOP sensor 300. In the example, the circuit board 320 supports first 301a, second 302b, third 302a, and fourth 301b thermistors. As noted in the example of FIG. 2, in some embodiments, the first thermistor 301a and the fourth thermistor 301b form a first pair of thermistors 321 and the second thermistor 302b and the third thermistor 302a and the second thermistor 302b form a second pair of thermistors 322. In some embodiments, the first pair of thermistors 321 are positioned in a first sensing area 331 and the second pair of thermistors 322 are positioned in a second sensing area 332. In some such embodiments, the housing 304 is configured such that the thermal resistance between the flow channel of the OOP sensor 300 and the first sensing area 331 is lower than the thermal resistance between the flow channel of the OOP sensor 300 and the second sensing area 332. In some such examples, fluid (e.g., a liquid from a product reservoir) flowing in the flow channel of the OOP sensor will have a greater impact on the temperature of the first pair of thermistors 321 compared to the second pair of thermistors 322. And in some examples, fluid flowing in the flow channel 308 (e.g., a liquid product) will affect the thermal behavior of the first pair of thermistors compared to an absence of the fluid (e.g., when only air is present in the flow channel).

While described as showing top and side views in FIGS. 3A and 3B, respectively, such labels are used for ease of reference and do not limit the orientation in which the OOP sensor 300 can be used during operation. In some examples, inlet 310 and outlet 312 are aligned vertically such that fluid flows upward through flow channel 308. Other orientations are possible.

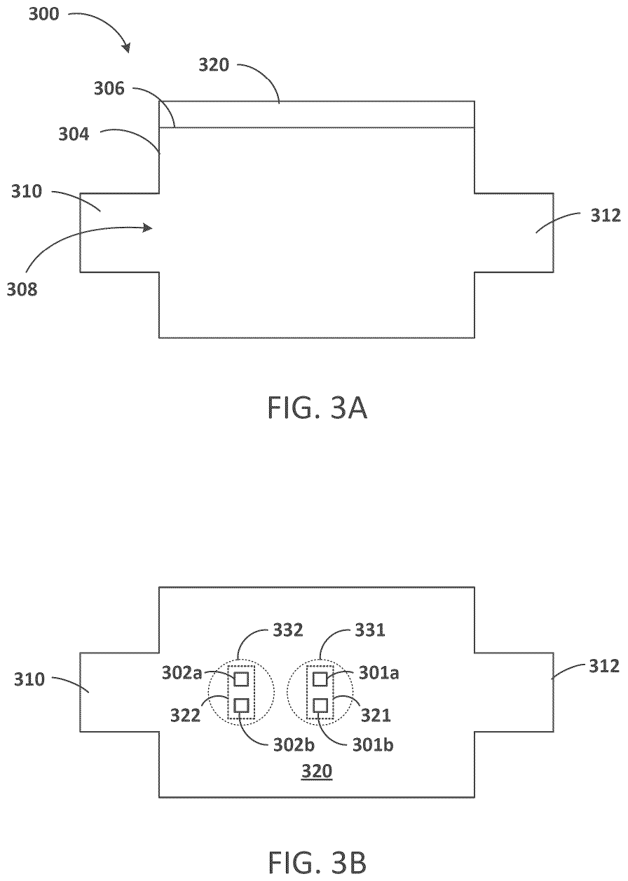

FIG. 4A shows an example cross-sectional view of an embodiment of an OOP sensor. The OOP sensor 400 of FIG. 4A includes a housing 404, a flow channel 408, an inlet 410 and an outlet 412 that each coupled the flow channel 408 to an exterior of the housing 404. In some examples, OOP sensor 400 is configured such that fluid flows in the direction of arrow 490. During example operation, OOP sensor can be oriented such that arrow 490 points upward and fluid flows vertically upwards through flow channel 408, though operating in other orientations is possible. The housing includes a first surface 406, and the OOP sensor 400 includes a circuit board 420 supported by the first surface of the housing.

In the example of FIG. 4A, flow channel 408 comprises a bend 409 toward the circuit board 420. The bend 409 can be configured to cause fluid flowing through the flow channel 408 to be directed more toward certain portions of the circuit board 420 than others. In some embodiments, the bend 409 in flow channel 408 directs fluid more toward a first sensing area, where a first pair of thermistors are located, compared a second sensing area, where a second pare of thermistors are located.

FIG. 4B shows a perspective exploded view of the OOP sensor of FIG. 4A. As shown, circuit board 420 is configured to engage first surface 406 of housing 404. In some examples, circuit board is between approximately 0.025 mm thick and 0.2 mm thick. In some examples, the circuit board comprises a glass epoxy laminate FR-4 or polyimide.

Circuit board 420 includes a first pair of thermistors 421 (e.g., including thermistor 401) located in a first sensing area 431 and a second pair of thermistors 422 (e.g., including thermistor 402) located in a second sensing area 432. In an example embodiment, when circuit board 420 engages the first surface 406 of the housing 404 (e.g., attached via threaded bolts configured to extend through corresponding holes in the circuit board 420 and engage corresponding threaded holes in the housing 404), the first sensing area 431 is positioned over the bend 409 in the flow channel 408, while second sensing area 432 is positioned closer to the inlet 410. In some examples, bend 409 directs fluid flowing in flow channel 408 toward the first sensing area 431, but does not direct fluid toward the second sensing area 432. Thus, in some examples, fluid flowing through the flow channel 408 will have a larger effect on the temperature of thermistors in the first sensing area 431 compared to the second sensing area 432.

For example, FIG. 4A shows a thermistor 401 in a first sensing area over bend 409 in flow channel 408 and a thermistor 402 in a second sensing area not over the bend 409. In some embodiments, the bend encourages fluid in the flow channel 408 toward thermistor 401 and not toward thermistor 402. In some such examples, temperature of thermistor 401 is more affected by fluid flowing in flow channel 408 than the temperature of thermistor 402.

In some examples, thermistors (e.g., in the first pair of thermistors 421 and/or the second pair of thermistors 422) are positioned on an inner surface of the circuit board 420 such that the thermistors face inward toward the flow channel. In some examples, a protective layer, such as an acrylic or Teflon film, is placed between the thermistors and the flow channel. In some examples, thermistors (e.g., in the first pair of thermistors 421 and/or the second pair of thermistors 422) are positioned on an outer side of the circuit board 420 such that the circuit board 420 is between the thermistors and the flow channel.

FIG. 4C shows another perspective exploded view of the OOP sensor of FIG. 4A.

In some examples, OOP sensor 400 includes a cap 460 configured to be coupled to the OOP sensor housing 404, for example, by one or more bolts (e.g., via threaded bolts configured to extend through corresponding holes in the circuit board 420 and the cap 460 and engage corresponding threaded holes in the housing 404). In some examples, cap 460 is placed over the circuit board 420 such that an inner surface of the cap 460 faces the circuit board 420. The inner surface of the cap 460 can include cavities to accommodate thermistors on the circuit board. In the example of FIG. 4, cavities 441 and 442 can be positioned such that, when the cap 460 is placed over the circuit board 420, the first pair of thermistors 421 are received in cavity 441 and the second pair of thermistors 422 are received in cavity 442. Cavities can provide air gaps around the thermistors to prevent heat loss from the thermistors, for example, by conduction of heat to cap 460 or other components of the OOP sensor 400.

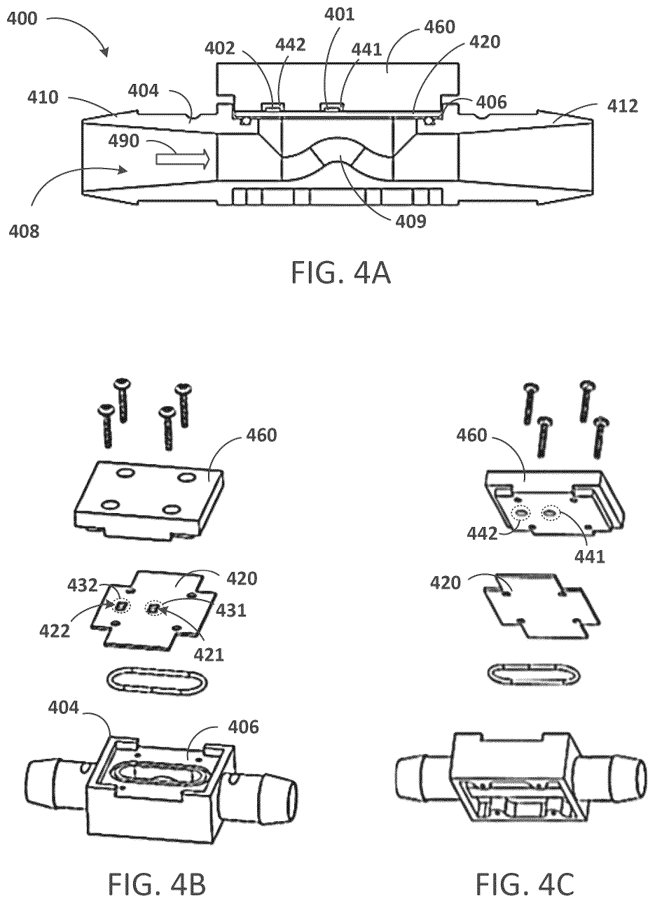

FIG. 5A shows an example cross-sectional view of an embodiment of an OOP sensor. The OOP sensor 500 of FIG. 5A includes a housing 504, a flow channel 508, an inlet 510 and an outlet 512 that each coupled the flow channel 508 to an exterior of the housing 504. In some examples, OOP sensor 500 is configured such that fluid flows in the direction of arrow 590. During example operation, OOP sensor can be oriented such that arrow 590 points upward and fluid flows vertically upwards through flow channel 508, though operating in other orientations is possible. The housing includes a first surface 506, and the OOP sensor 500 includes a circuit board 520 supported by the first surface of the housing.

In the example of FIG. 5A, flow channel 508 comprises a bend 509 toward the circuit board 520. The bend 509 can be configured to cause fluid flowing through the flow channel 508 to be directed more toward certain portions of the circuit board 520 than others. In some embodiments, the bend 509 in flow channel 508 directs fluid more toward a first sensing area, where a first pair of thermistors are located, compared a second sensing area, where a second pare of thermistors are located.

FIG. 5B shows a perspective exploded view of the OOP sensor of FIG. 5A. As shown, circuit board 520 is configured to engage first surface 506 of housing 504. In some examples, circuit board is between approximately 0.025 mm thick and 0.2 mm thick. In some examples, the circuit board comprises a glass epoxy laminate FR-4 or polyimide.

OOP sensor 500 includes an insert 550, for example, a plastic insert, configured to be inserted into an aperture 507 in the first surface 506 of the housing 504. In some examples, the insert engages with a portion of the flow channel 508. For instance, in some embodiments, the housing 504 defines a first half of a tubular flow channel 508 and the insert 550 comprises an inner surface defining a second half of a tubular flow channel. In some such embodiments, when the insert is inserted into the aperture in the first surface 506 of the housing 504, the flow channel defined by the housing 504 and the inner surface of the insert 550 join to form a closed tubular flow channel.

The insert 550 as shown includes an aperture 552 extending therethrough. In some examples, the aperture 552 provides a fluid path between the flow channel 508 and the circuit board 520 when the OOP sensor 500 is assembled.

Circuit board 520 includes a first pair of thermistors 521 (e.g., including thermistor 501) located in a first sensing area 531 and a second pair of thermistors 522 (e.g., including thermistor 502) located in a second sensing area 532. In an example embodiment, when circuit board 520 engages the first surface 506 of the housing 504 (e.g., attached via threaded bolts configured to extend through corresponding holes in the circuit board 520 and engage corresponding threaded holes in the housing 504), the first sensing area 531 is positioned over the aperture 552 in the insert 550 that forms a second half of the flow channel 508 at bend 509, while second sensing area 532 is positioned closer to the inlet 510 and is not positioned over the aperture 552. In some examples, bend 509 directs fluid flowing in flow channel 508 toward the first sensing area 531, but does not direct fluid toward the second sensing area 532. Additionally or alternatively, the aperture 552 in the insert 550 allows fluid in the flow channel 508 to reach the circuit board 520 at the first sensing area 531 while preventing the fluid in the flow channel 508 from reaching the circuit board 520 at the second sensing area 532. Thus, in some examples, fluid flowing through the flow channel 508 will have a larger effect on the temperature of thermistors in the first sensing area 531 compared to the second sensing area 532.

For example, FIG. 5A shows a thermistor 501 in a first sensing area over aperture 552 in insert 550 and a thermistor 502 in a second sensing area not over aperture 552. In some embodiments, the insert 550 provides thermal insulation between the flow channel 508 and thermistor 502, but not between flow channel 508 and thermistor 501 due to aperture 552.

In some examples, a protective layer is positioned between thermistors in the first sensing area 531 (e.g., in the first pair of thermistors 521 in the first sensing area 531) and flow channel 508. In some examples, the thermistors are positioned on a first surface of the circuit board 520 such that the circuit board 520 is between the thermistors and the flow channel 508. In some such examples, the circuit board 520 serves as the protective layer. In other examples, the thermistors are positioned on an inner surface of the circuit board 520 such that the thermistors face the flow channel 508. In some examples, an acrylic or Teflon protective layer can be positioned over the thermistors to form a protective layer between the thermistors and the flow channel 508.

FIG. 5C shows another perspective exploded view of the OOP sensor of FIG. 5A.

In some examples, OOP sensor 500 includes a cap 560 configured to be coupled to the OOP sensor housing 504, for example, by one or more bolts (e.g., via threaded bolts configured to extend through corresponding holes in the circuit board 520 and the cap 560 and engage corresponding threaded holes in the housing 504). In some examples, cap 560 is placed over the circuit board 520 such that an inner surface of the cap 560 faces the circuit board 520. The inner surface of the cap 560 can include cavities to accommodate thermistors on the circuit board. In the example of FIG. 5, cavities 541 and 542 can be positioned such that, when the cap 560 is placed over the circuit board 520, the first pair of thermistors 521 are received in cavity 541 and the second pair of thermistors 522 are received in cavity 542. Cavities can provide air gaps around the thermistors to prevent heat loss from the thermistors, for example, by conduction of heat to cap 560 or other components of the OOP sensor 500.

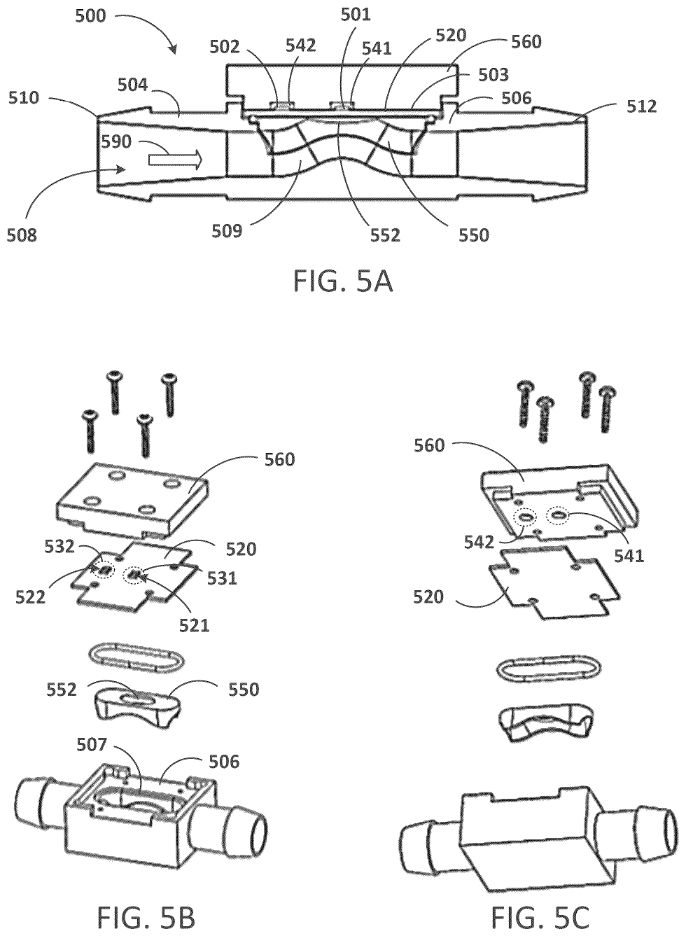

FIG. 6A shows an example cross-sectional view of an embodiment of an OOP sensor. The OOP sensor 600 of FIG. 6A includes a housing 604, a flow channel 608, an inlet 610 and an outlet 612 that each coupled the flow channel 608 to an exterior of the housing 604. In some examples, OOP sensor 600 is configured such that fluid flows in the direction of arrow 690. During example operation, OOP sensor can be oriented such that arrow 690 points upward and fluid flows vertically upwards through flow channel 608, though operating in other orientations is possible. The housing includes a first surface 606, and the OOP sensor 600 includes a circuit board 620 supported by the first surface of the housing. In the example of FIG. 6A, flow channel 608 comprises a cylindrical flow channel, and the first surface 606 of the housing 604 and the circuit board 620 are curved.

FIG. 6B shows a perspective exploded view of the OOP sensor of FIG. 6A. As shown, circuit board 620 is curved configured to engage a curved first surface 606 of housing 604. In some examples, circuit board is between approximately 0.025 mm thick and 0.2 mm thick. In some examples, the circuit board comprises a glass epoxy laminate FR-4 or polyimide. In some examples, the circuit board 620 is not curved when standing alone, but is flexible and curves upon engaging curved first surface 606 of housing 604.

OOP sensor 600 includes an aperture 607 in the first surface 606 of the housing 604. In some examples, the aperture 607 provides a fluid path between the flow channel 608 and the circuit board 620 when the OOP sensor 600 is assembled.

Circuit board 620 includes a first pair of thermistors 621 (e.g., including thermistor 601) located in a first sensing area 631 and a second pair of thermistors 622 (e.g., including thermistor 602) located in a second sensing area 632. In an example embodiment, when circuit board 620 engages the first surface 606 of the housing 604 (e.g., attached via threaded bolts configured to extend through corresponding holes in the circuit board 620 and engage corresponding threaded holes in the housing 604), the first sensing area 631 is positioned over the aperture 607 in the first surface 606 of the housing 604, while second sensing area 632 is positioned closer to the inlet 610 and is not positioned over the aperture 607. In some examples, the aperture 607 allows fluid in the cylindrical flow channel 608 to reach the circuit board 620 at the first sensing area 631 while preventing the fluid in the flow channel 608 from reaching the circuit board 620 at the second sensing area 632. Additionally or alternatively, in some embodiments, the curved first surface 606 of housing 604 is further separates the second sensing area 632 from the flow channel 608 compared to the first sensing are 631, and in some examples, the first surface 606 is thicker in an area of the second sensing area 632 compared to the first sensing area 631 and provides as greater thermal resistance between the second sensing area 632 and the flow channel 608 compared to that between the first sensing area 631 and the flow channel 608. Thus, in some examples, fluid flowing through the flow channel 608 will have a larger effect on the temperature of thermistors in the first sensing area 631 compared to the second sensing area 632.

For example, FIG. 6A shows a thermistor 601 in a first sensing area and a thermistor 602 in a second sensing area. In some embodiments, the first surface 606 of housing 604 comprises an aperture below thermistor 601. In some examples, first surface 606 of housing 604 provides thermal insulation between the flow channel 608 and thermistor 602, but not between flow channel 608 and thermistor 601 due to an aperture in the first surface 606. Additionally or alternatively, in some examples, the curved first surface is thicker between thermistor 602 and flow channel 608 compared to between thermistor 601 and flow channel 608 and provides larger thermal resistance between flow channel 608 and thermistor 602 compared to between flow channel 608 and thermistor 601.

In some examples, a protective layer is positioned between thermistors in the first sensing area 631 (e.g., the first pair of thermistors 621 in the first sensing area 631) and flow channel 608. In some examples, the thermistors are positioned on a first surface of the circuit board 620 such that the circuit board 620 is between the thermistors and the flow channel 608. In some such examples, the circuit board 620 serves as the protective layer. In other examples, the thermistors are positioned on an inner surface of the circuit board 620 such that the thermistors face the flow channel 608. In some examples, an acrylic or Teflon protective layer can be positioned over the thermistors to form a protective layer between the thermistors and the flow channel 608.

FIG. 6C shows another perspective exploded view of the OOP sensor of FIG. 6A.

In some examples, OOP sensor 600 includes a cap 660 configured to be coupled to the OOP sensor housing 604, for example, by one or more bolts (e.g., via threaded bolts configured to extend through corresponding holes in the circuit board 620 and the cap 660 and engage corresponding threaded holes in the housing 604). In some examples, cap 660 is placed over the circuit board 620 such that an inner surface of the cap 660 faces the circuit board 620. The inner surface of the cap 660 can include cavities to accommodate thermistors on the circuit board. In the example of FIG. 6, cavities 641 and 642 can be positioned such that, when the cap 660 is placed over the circuit board 620, the first pair of thermistors 621 are received in cavity 641 and the second pair of thermistors 622 are received in cavity 642. Cavities can provide air gaps around the thermistors to prevent heat loss from the thermistors, for example, by conduction of heat to cap 660 or other components of the OOP sensor 600.

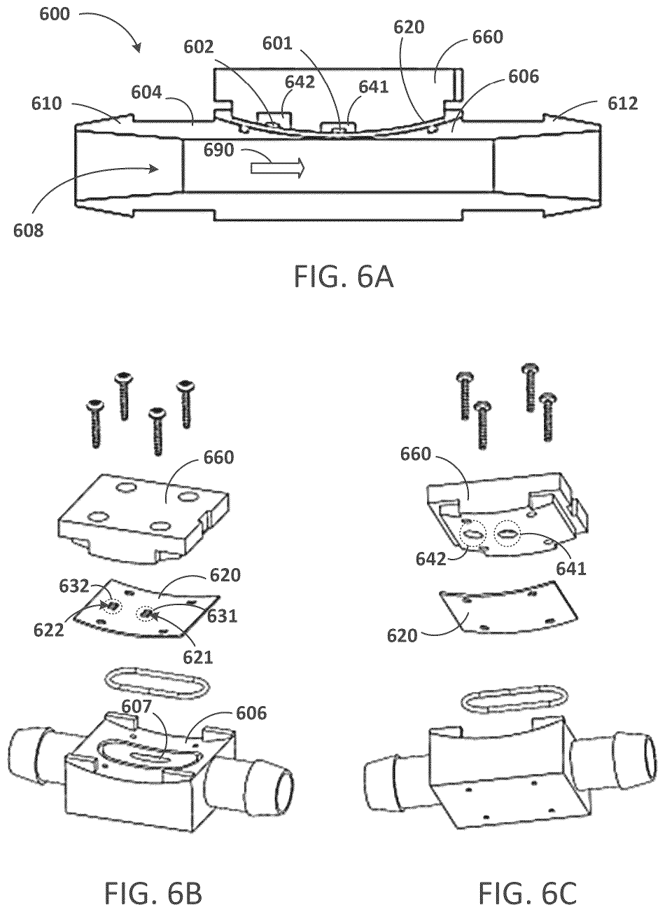

FIG. 7 shows an example cross-sectional view of an embodiment of an OOP sensor. The OOP sensor 700 of FIG. 7 includes a housing 704, a flow channel 708, an inlet 710 and an outlet 712 that each coupled the flow channel 708 to an exterior of the housing 704. In some examples, OOP sensor 700 is configured such that fluid flows in the direction of arrow 790. During example operation, OOP sensor can be oriented such that arrow 790 points upward and fluid flows vertically upwards through flow channel 708, though operating in other orientations is possible. The housing includes a first surface 706, and the OOP sensor 700 includes a circuit board 720 supported by the first surface of the housing. In the example of FIG. 7, flow channel 708 comprises a cylindrical flow channel, and the first surface 706 of the housing 704 and the circuit board 720 are curved.

As shown, circuit board 720 is curved configured to engage a curved first surface 706 of housing 704. In some examples, circuit board is between approximately 0.025 mm thick and 0.2 mm thick. In some examples, the circuit board comprises a glass epoxy laminate FR-4 or polyimide. In some examples, the circuit board 720 is not curved when standing alone, but is flexible and curves upon engaging curved first surface 706 of housing 704.

In some embodiments, circuit board 720 includes a first pair of thermistors (e.g., including thermistor 701) located in a first sensing 731 area and a second pair of thermistors (e.g., including thermistor 702) located in a second sensing area 732. In the illustrated example of FIG. 7, the first surface 706 of the housing 704 is thicker between the cylindrical flow channel 708 and the second sensing area 732 compared to between the cylindrical flow channel 708 and the first sensing area 731. In some such examples, the thicker first surface 706 of the housing 704 provides a greater thermal resistance between the flow channel and the respective sensing area. Thus, in some examples, fluid flowing through the flow channel 708 will have a larger effect on the temperature of thermistors in the first sensing area 731 compared to the second sensing area 732. In some examples, the housing 704 forms a fully enclosed flow channel 708 having a first surface 706 having areas of different thickness to provide different degrees of thermal insulation between the flow channel 708 and a sensing area opposite first surface 706 from the flow channel 708. In some examples, having the first surface 706 of the housing 704 enclosing the flow channel 708 can protect the circuit board 720 and/or components thereon (e.g., one or more thermistors) from fluid flowing in the flow channel 708, such as aggressive fluids that can damage such components.

In some examples, OOP sensor 700 includes a cap 760 configured to be coupled to the OOP sensor housing 704, for example, by one or more bolts (e.g., via threaded bolts configured to extend through corresponding holes in the circuit board 720 and the cap 760 and engage corresponding threaded holes in the housing 704). In some examples, cap 760 is placed over the circuit board 720 such that an inner surface of the cap 760 faces the circuit board 720. The inner surface of the cap 760 can include cavities to accommodate thermistors on the circuit board. In the example of FIG. 7, cavities 741 and 742 can be positioned such that, when the cap 760 is placed over the circuit board 720, thermistor 701 is received in cavity 741 and thermistor 702 is received in cavity 742. Cavities can provide air gaps around the thermistors to prevent heat loss from the thermistors, for example, by conduction of heat to cap 760 or other components of the OOP sensor 700.

As described, in various examples, an OOP sensor can include at least a first sensing area and a second sensing area, and can be configured such that thermal resistance between the flow channel and the first sensing area is lower than thermal resistance between the flow channel and the second sensing area, and/or fluid flowing in the flow channel is directed more toward the first sensing area than the second sensing area. In some examples, a bend in a flow channel can direct fluid toward the first sensing area, for example, as shown in the embodiment of FIG. 4A. Additionally or alternatively, in some examples, an OOP sensor can include an obstruction in the flow channel configured to alter the flow of fluid through the channel and direct fluid in the flow channel toward a sensing area (e.g., the first sensing area).

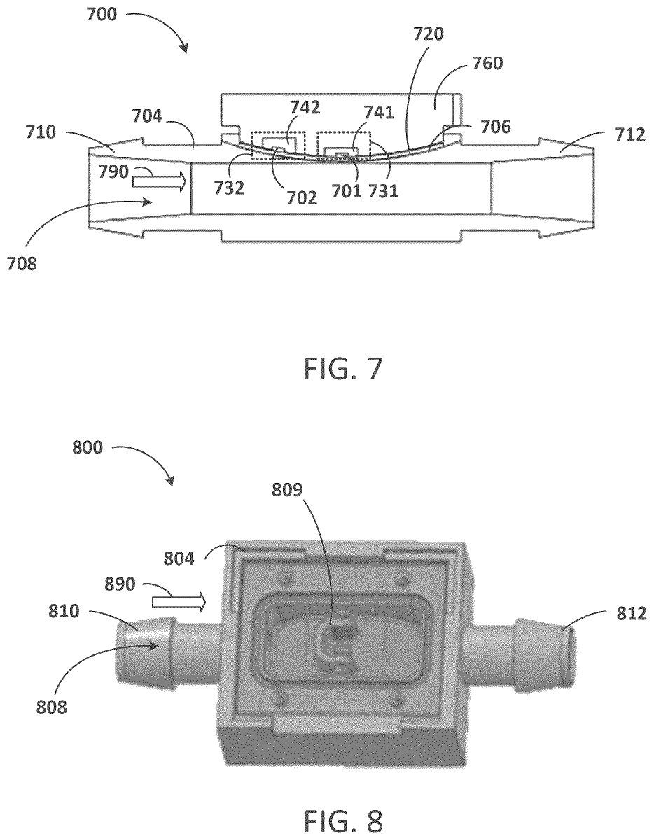

FIG. 8 shows an example OOP sensor. The OOP sensor 800 of FIG. 8 includes a housing 804, a flow channel 808, an inlet 810 and an outlet 812 that each coupled the flow channel 808 to an exterior of the housing 804. In some examples, OOP sensor 800 is configured such that fluid flows in the direction of arrow 890. During example operation, OOP sensor can be oriented such that arrow 890 points upward and fluid flows vertically upwards through flow channel 808, though operating in other orientations is possible. The OOP sensor of FIG. 8 includes an obstruction 809 positioned within the flow channel 808 that can alter the flow of fluid through the flow channel 808. The obstruction 809 in FIG. 8 comprises a U-shaped wall, though other shapes of obstructions are possible. In some examples, an obstruction (e.g., 809) can be configured to direct fluid flowing in flow channel (e.g., 808) toward a first sensing area and not toward a second sensing area.

While the illustrated examples include an arrow indicating a flow direction (e.g., 490, 590, 690, 790, 890), in some examples, OOP sensors as shown and described herein can operate as fluid flows therethrough in either direction. For instance, in some examples, while described as including inlets and outlets coupled to the flow channel, various OOP sensors can be configured to receive fluid at either the inlet or the outlet such that fluid flows from inlet or the outlet to the other of the inlet or the outlet. In some embodiments, OOP sensor is symmetric such that similar measurements can be used to detect the presence or absence of fluid in the OOP sensor when fluid is configured to flow through the OOP in either direction.

As described, in some examples, the OOP sensor can be configured such that a fluid flowing through a flow channel thereof (e.g., a liquid product from a product reservoir) will have a larger impact on a temperature of thermistors in a first sensing area compared to thermistors in a second sensing area, for example, due to lower thermal resistance between the flow channel and the first sensing area compared to between the flow channel and the second sensing area and/or directing fluid toward the first sensing area and not the second sensing area.

FIG. 2 illustrates an example connection of thermistors 1a, 1b, 2a, 2b to the power supply 6. Typically, when thermistors are utilized to measure temperature, current passing through them is regulated to restrict power dissipation within the thermistor. Thermistors alter their resistance in response to temperature changes. In such cases, the resistance reflects the ambient temperature.

In some examples of operating an OOP sensor according to the present disclosure, a high current pulse is briefly applied to the thermistors, causing a momentary change in their temperature. In some embodiments, this temperature variation can exceed 20° C. and, in some instances, reach up to or above 100° C.

In an example embodiment, thermistors 1a, 1b, 2a, 2b employed in the OOP sensor are NTC thermistors, which introduce positive feedback over time. When a constant voltage V is applied to the NTC thermistor, the dissipated power P initially starts from P₀=V²/Rₜ₀, where Rₜ₀ represents the resistance at the beginning. Nonetheless, the heightened temperature lowers the thermistor's resistance, causing the current to escalate over time unless the applied voltage is diminished or turned off. The inclusion of a constant resistor (e.g., current limiting resistor 3) in series with the thermistors safeguards them from potential damage.

As depicted in the electrical circuit diagram of FIG. 2, the thermistors 1a, 1b, 2a, 2b are arranged in a bridge 10, and a current limiting resistor 3 is connected in series. The selection of nominal resistance values for the thermistors, the limiting resistor, and the applied voltage is strategic, allowing rapid self-heating without endangering the thermistors. In the proposed configuration, self-heating (e.g., application of a voltage from power supply 6) elevates the temperature of all thermistors similarly. This uniformity in temperature results from the short duration of preheating and the more gradual nature of heat transfer. Consequently, the thermistors exhibit similar temperatures during the self-heating process. Once the voltage is deactivated, the thermistors' temperatures begin to decline as heat dissipates into the surroundings. The rates of heat transfer can vary when different materials are in proximity to the thermistors, enabling the differentiation between fluids and air. As described elsewhere herein, short pulses of voltage applied to the thermistor bridge can be used to allow reading signals from one or more thermistors without heating it. As temperatures of one or more thermistors of the thermistor bridge 10 change, resulting changes in thermistor resistances can result in different signals received, for example, at ADC 7.

As described elsewhere herein, in some examples, thermistors 1a, 1b form a first pair of thermistors and thermistors 2a, 2b form a second pair of thermistors. In some examples, the first pair of thermistors are positioned in a first sensing area while the second pair of thermistors are positioned in a second sensing area, wherein the first sensing area is more susceptible to having its thermistor temperatures affected by fluid flowing in the flow channel of the OOP sensor. In an example embodiment, each of thermistors 1a, 1b, 2a, and 2b have the same resistance vs. temperature relationship. In such an example, if all thermistors are the same temperature and same resistance, then the voltage drop across thermistor 1a and thermistor 2a will be the same, and the voltage difference between points 11 and 12 will be zero. If thermistors 1a and 1b are the same temperature and thermistors 2a and 2b are the same temperature, and thermistors 1a and 1b have lower resistance than thermistors 2a and 2b, for example, due to temperature effects of a fluid in the flow channel, then thermistor 1a will drop less voltage than thermistor 2a and the voltage difference between points 11 and 12 will be non-zero. Thus, in some examples, deviations in temperature between a first sensing area and a second sensing area can result in changes in the voltage difference between points 11 and 12, such as measured at input 7a of ADC 7 in FIG. 2. In some examples, a signal at input 7b (representative of a voltage drop across thermistor 2b) represents a general temperature level of the thermistors in the second sensing area.

During example operation, a controller (e.g., controller 5 in FIG. 2) can be configured to interact with a plurality of thermistors (e.g., 1a, 1b, 2a, 2b in FIG. 2) in order to detect whether a product is present in the flow channel of the OOP sensor. With reference to FIG. 2, in an example embodiment, the controller 5 is configured to place the switch 4 into an on state to cause current to flow from the power supply 6 to the thermistor bridge 10 to heat one or more thermistors of the thermistor bridge 10. In the example of FIG. 2, current from the power supply 6 flows through both the first branch and the second branch of the thermistor bridge to the reference potential. In some examples, the current through thermistors causes the temperature of the thermistors to rise. Fluid flowing through the flow channel of an OOP sensor can affect the temperatures of the thermistors differently, for example, affecting thermistors in a first sensing area more than thermistors in a second sensing area.

In some examples, controller is configured to place the switch into an on state to cause current to flow from the power supply to the thermistor bridge for a heating time duration. In some examples, heating time duration is between 1 ms and 1000 ms. In some examples, the controller 5 is configured to place the switch 4 into an off state to stop current flowing to the thermistor bridge 10 and maintain the switch in the off state for a delay time duration. In some examples, delay time duration is between 1 ms and 1000 ms. After the delay time duration and during a reading time duration, the controller 5 is configured to provide a plurality of measurement pulses to the thermistor bridge 10, for example, by transitioning the switch 4 between an off and on state. In some embodiments, reading time duration is between 10 ms and 2000 ms. In some examples, each measurement pulse has a measurement pulse time duration (e.g., a time the switch is in the on state) of between 0.1 ms and 5 ms and being provided at a measurement frequency of between 10 Hz and 100 Hz. For instance, in some examples, the time between the leading edge of consecutive pulses is between 10 ms and 100 ms.

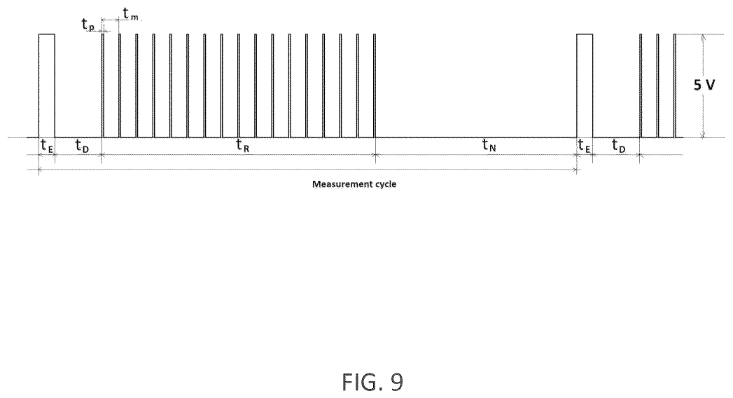

FIG. 9 is an example voltage vs. time plot showing a voltage output from switch 4. For instance, in some examples, the power supply 6 is configured to output 5 VDC and switch controls whether 5 VDC is output from switch. In the illustrated example, controller 5 controls switch 4 to provide power to the thermistor bridge 10 during an excitation time the, to stop providing power for a delay time to, to provide a series of excitations pulses during reading time t_{R}, each measurement pulse having a reading pulse time tₚ, the leading edge of each pulse being separated by a measuring period tₘ. After a series of measurement pulses during reading time, the controller 5 can cause switch 4 to stop providing power to the thermistor bridge 10 for a normalization time t_{N}. During the normalization time, thermistors can return to an equilibrium temperature. In some examples, the excitation time, delay time, reading time, and normalization time combine to form a measurement cycle. In some examples, measurement cycle can be repeated over time.

In some examples, the excitation time can be between 1 ms and 1000 ms, the delay time can be between 1 ms and 1000 ms, the reading time can be between 10 ms and 2000 ms, the normalization time can be between 10 ms and 10,000 ms, the reading pulses can be between 0.1 ms and 5 ms, and the measuring period can be between 5 ms and 200 ms. In various embodiments, one or more such times can be adjustable.

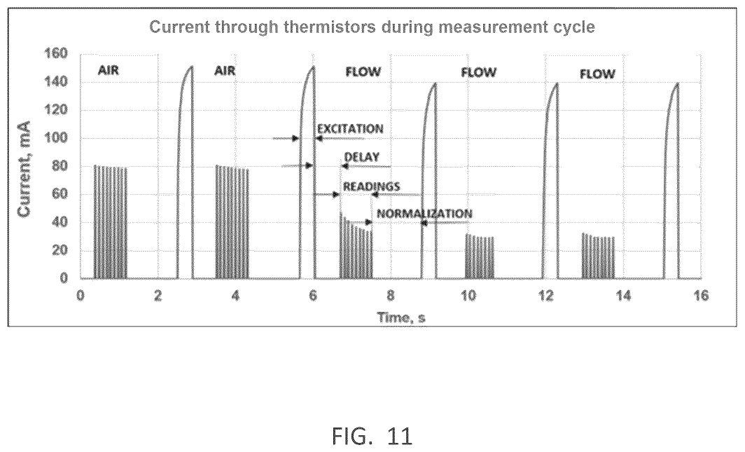

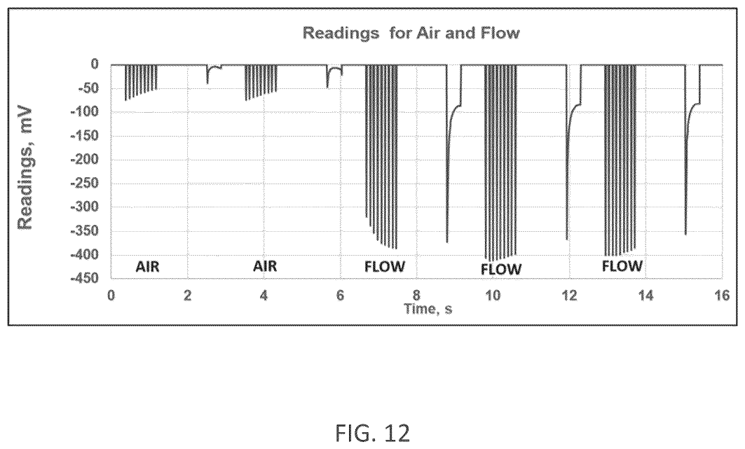

FIG. 11 shows example current pulses through the thermistor bridge for an example embodiment. FIG. 12 shows example readings measured at the input 7a and example corresponding flow status indications based on the readings.

The controller 5 can be configured to, during each of the plurality of measurement pulses, receive a measurement signal value. In some examples, the measurement signal value is representative of a voltage between points 11 and 12 of the thermistor bridge 10. In some examples, the measurement signal value is an output from ADC 7 in communication with points 11 and 12. In some examples, the measurement signal is a voltage. In some examples, the measurement signal corresponds to a temperature difference between thermistors in the first sensing area and the second sensing area.

In some embodiments, the measurement pulses are sufficiently short so as to not significantly change the temperature of the thermistor(s), but is sufficiently long to determine a measurement signal value during the measurement pulse. In some examples, current limiting resistor 3 suppresses current flowing through the thermistors during the measurement pulses to prevent heating of the thermistors. Additionally or alternatively, in some examples, current limiting resistor 3 suppresses current flowing through the thermistors during the heating time duration to prevent damage to the thermistors. In some examples, power supply 6 provides a 5 VDC output. In some examples, current limiting resistor is between approximately 10 ohms and 100 ohms. In some examples, the resistance of thermistors range between approximately 30 ohms and 100 ohms across a range of operating temperatures.

In some embodiments, controller 5 is further configured to receive a second signal representative of a voltage drop across one thermistor (e.g., representative of a signal received as second input 7b of ADC 7 related to a voltage drop across thermistor 1b). In some examples, the second signal provides an indication of the temperature of the thermistors in the first sensing area. In some examples, the temperature of such thermistors can be used to make a temperature correction of the measurement signal value. Thus, in some examples, a measurement pulse is used to receive a measurement signal value based on a voltage drop between points 11 and 12 in FIG. 2, and the controller can be configured to receive a second signal representative of the voltage drop across thermistor 2b. Controller 5 can use the second signal representative of a temperature of the second sensing area to determine a corrected measurement signal value. For example, corrections (e.g., polynomial corrections) can be used to compensate for hot or cold fluid flowing through the OOP sensor.

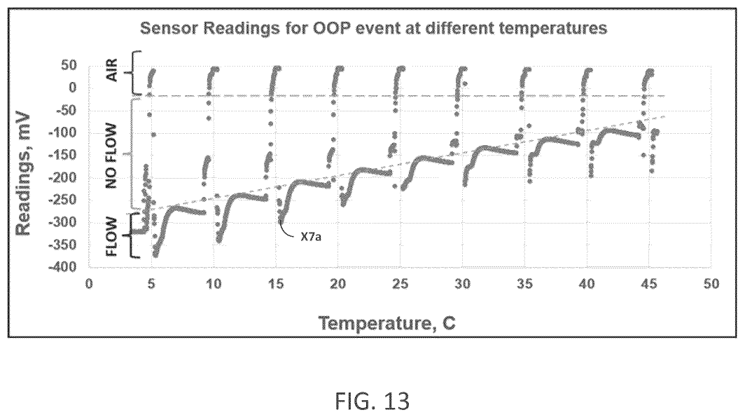

FIG. 13 shows an example plot of a measurement signal in various flow states as a function of temperature. In FIG. 13, the diverse profiles of an example first signal X7a (e.g., a measurement signal generated from input 7a of the ADC 7 in FIG. 2) for distinct OOP occurrences at varying temperatures are demonstrated. The temperature variation in the first signal X7a can be mitigated by applying a multiplication of X7a with an adjustable correction coefficient. In some examples, the correction coefficient can be constructed as a fourth-order polynomial of the second signal X7b (e.g., input 7b of the ADC 7 in FIG. 2). For instance, in an example embodiment, a corrected signal X7a_corr can be calculated for each measurement using the equation:

$$X7a\_corr = X 7 a ( 1 + ( X 7 b 0 - X 7 b ) ( A + ( X 7 b 0 - X 7 b ) ( B + ( X 7 b 0 - X 7 b ) ( C + D ( X 7 b 0 - X 7 b ) ) ) ) )$$

where X₇ₐ and X_{7b} are currently measured first and second signals, and X₇₆₀, A, B, C, D are constants recorded in controller memory. In some cases, such constants can be calculated during a factory calibration.

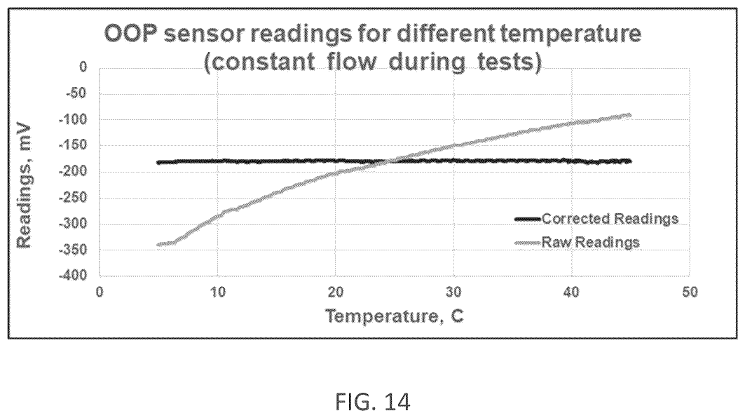

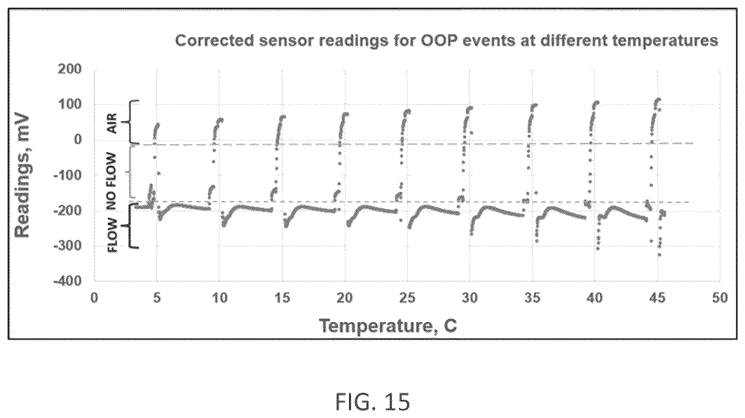

In some examples, such a temperature correction mechanism effectively addresses scenarios involving the passage of fluids at different temperatures through the sensor, as depicted in FIG. 14, which shows an example plot of raw and corrected sensor readings over a range of different temperatures at a constant flow rate. Similarly, its efficacy extends to OOP events captured under varying temperature conditions, as illustrated in FIG. 15, which shows corrected sensor readings over a range of temperatures for different flow statuses over a range of different temperatures.

While the plots in FIGS. 11-15 include units on both the horizontal and vertical axes, such plots show example operation according to some embodiments. Other values, such as other currents, voltages, timescales, are possible.

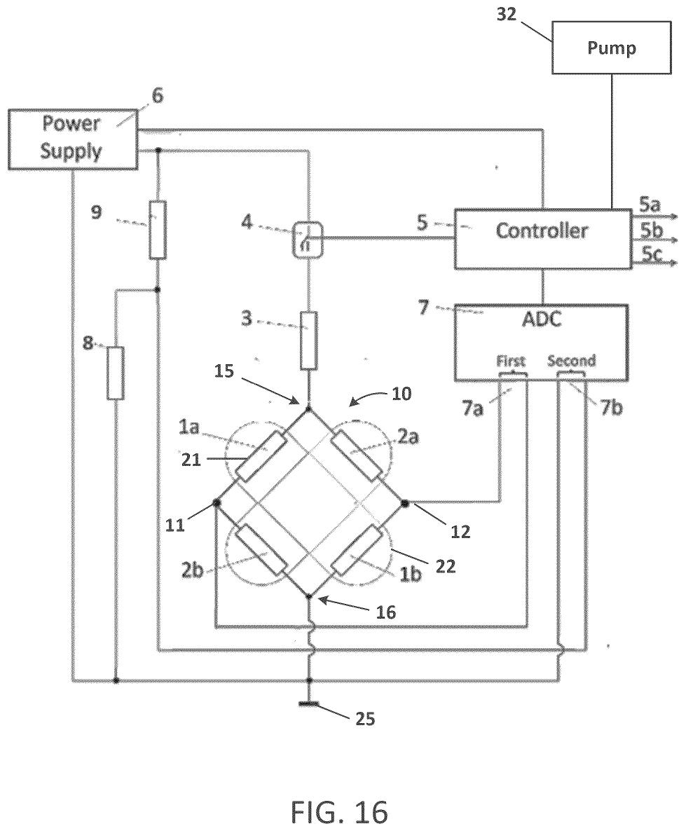

Other temperature measurement and/or correction techniques are possible. In some embodiments, a stand-alone thermistor can be used to measure a temperature. FIG. 16 shows an alternative example schematic diagram of aspects of an out of product sensing system including a standalone thermistor. Similar to the example of FIG. 2, the example of FIG. 16 shows a thermistor bridge 10 comprises a plurality of thermistors, including a first thermistor 1a, a second thermistor 2b, a third thermistor 2a, and a fourth thermistor 1b. In the illustrated example, the thermistor bridge 10 comprises a first branch comprising the first thermistor 1a in series with the second thermistor 2b, with a first point 11 between the first thermistor 1a and the second thermistor 2b. The thermistor bridge 10 further comprises a second branch comprising the third thermistor 2a in series with the fourth thermistor 1b, with a second point 12 between the third thermistor 2a and the fourth thermistor 1b. In some examples, as described elsewhere herein, the first thermistor 1a and the fourth thermistor 1b for a first pair of thermistors 21 and the second thermistor 2b and the third thermistor 2a form a second pair of thermistors 22. The first branch and the second branch are arranged in parallel between a powered side 15 of the thermistor bridge 10 and a reference side 16 of the thermistor bridge 10. In the illustrated example, the first thermistor 1a and the third thermistor 2a are coupled to the powered side 15 of the thermistor bridge 10 and the second thermistor 2b and the fourth thermistor 1b are coupled to the reference side 16 of the thermistor bridge 10.

Components of FIG. 16 can operate in similar ways as like numbered described with respect to FIG. 2. Power supply 6 can provide power to the powered side 15 of the thermistor bridge 10 via a switch 4 controlled by controller 5. A resistor 3 can limit the current provided to the thermistor bridge 10. A first input 7a of ADC 7 can be configured to receive a signal representative of the voltage difference between the first point 11 and the second point 12, which can provide information regarding deviations in temperature between a first sensing area and a second sensing area of an OOP sensor.

In the example of FIG. 16, a standalone thermistor 8 can receive power from the power supply 6 through a loading resistor 9 in series with the standalone thermistor 8. The standalone thermistor 8 can be supported by the circuit board in a location near the thermistor bridge 10. In the illustrated example, loading resistor 9 receives a constant voltage from the power supply 6. In some embodiments, the loading resistor 9 and standalone thermistor 8 have high resistance to decrease the load current resulting from the voltage from power supply 6 and to decrease self-heating. For example, in some embodiments, the nominal resistance for the thermistor and for load resistor can be selected from between approximately 10 kΩ and 100 kΩ.

In the illustrated example, the loading resistor 9 and the standalone thermistor 8 are in series between the power supply 6 and the reference potential 25. If the temperature, and therefore, the resistance, of the standalone thermistor 8 changes, the amount of the voltage from power supply 6 dropped by standalone thermistor 8 also changes. Thus, the voltage dropped by the standalone thermistor 8 is a function of the temperature of the standalone thermistor.

In the example of FIG. 16, instead of receiving a signal representative of a voltage drop across thermistor 2b as in FIG. 2, the second input 7b of ADC is configured to receive a signal representative of a voltage drop across the standalone thermistor 8, which corresponds to the temperature of the standalone thermistor 8.

In an example implantation, the controller 5 is configured to receive an input from the ADC based on the signal at the second input 7b of the ADC and can be configured to determine the temperature of the standalone thermistor 8 based on the received input. In some embodiments, a temperature can be calculated based on a measured voltage at the second input 7b corresponding to the voltage across standalone thermistor 8. In an example embodiment, the temperature is calculated using a second order polynomial fit as a function of voltage, where the thermistor temperature T=AV²+BV+C, where A, B, and C are constants and V is the voltage at the second input 7b across the standalone thermistor 8. Constants A, B, C can be determined empirically. In an example, A=1.27×10⁻⁶, B=−6.32×10⁻², C=78.6.

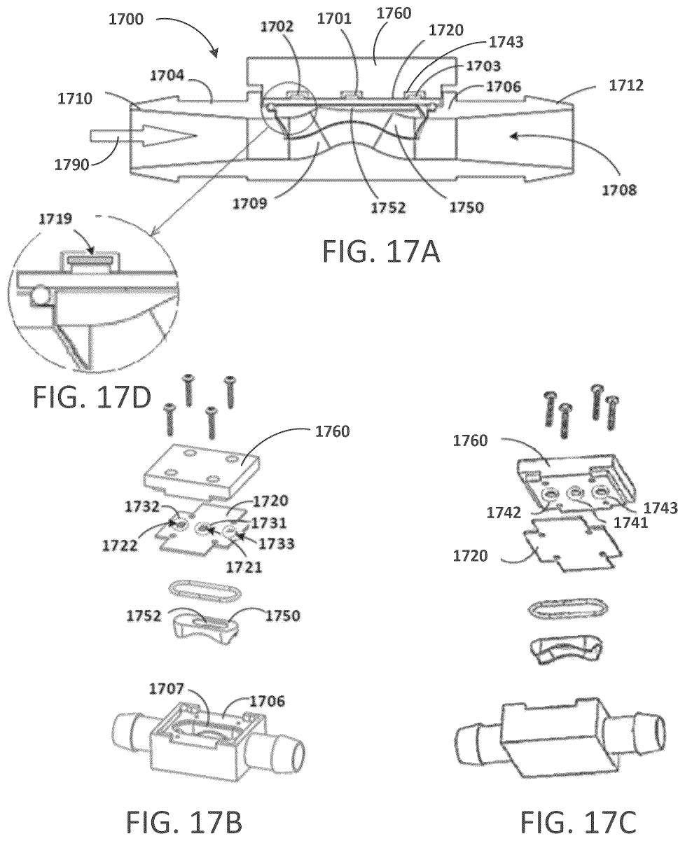

FIG. 17A shows an example cross-sectional view of an embodiment of an OOP sensor including a standalone thermistor in addition to a thermistor bridge. The OOP sensor 1700 of FIG. 17A includes a housing 1704, a flow channel 1708, an inlet 1710 and an outlet 1712 that each coupled the flow channel 1708 to an exterior of the housing 1704. In some examples, OOP sensor 1700 is configured such that fluid flows in the direction of arrow 1790. During example operation, OOP sensor can be oriented such that arrow 1790 points upward and fluid flows vertically upwards through flow channel 1708, though operating in other orientations is possible. The housing includes a first surface 1706, and the OOP sensor 1700 includes a circuit board 1720 supported by the first surface of the housing.

In the example of FIG. 17A, flow channel 1708 comprises a bend 1709 toward the circuit board 1720. The bend 1709 can be configured to cause fluid flowing through the flow channel 1708 to be directed more toward certain portions of the circuit board 1720 than others. In some embodiments, the bend 1709 in flow channel 1708 directs fluid more toward a first sensing area, where a first pair of thermistors are located, compared a second sensing area, where a second pare of thermistors are located.

FIG. 17B shows a perspective exploded view of the OOP sensor of FIG. 17A. As shown, circuit board 1720 is configured to engage first surface 1706 of housing 1704. In some examples, circuit board is between approximately 0.025 mm thick and 0.2 mm thick. In some examples, the circuit board comprises a glass epoxy laminate FR-4 or polyimide.

OOP sensor 1700 includes an insert 1750, for example, a plastic insert, configured to be inserted into an aperture 1707 in the first surface 1706 of the housing 1704. In some examples, the insert engages with a portion of the flow channel 1708. For instance, in some embodiments, the housing 1704 defines a first half of a tubular flow channel 1708 and the insert 1750 comprises an inner surface defining a second half of a tubular flow channel. In some such embodiments, when the insert is inserted into the aperture in the first surface 1706 of the housing 1704, the flow channel defined by the housing 1704 and the inner surface of the insert 1750 join to form a closed tubular flow channel.

The insert 1750 as shown includes an aperture 1752 extending therethrough. In some examples, the aperture 1752 provides a fluid path between the flow channel 1708 and the circuit board 1720 when the OOP sensor 1700 is assembled.

Circuit board 1720 includes a first pair of thermistors 1721 (e.g., including thermistor 1701) located in a first sensing area 1731 and a second pair of thermistors 1722 (e.g., including thermistor 1702) located in a second sensing area 1732. In an example embodiment, when circuit board 1720 engages the first surface 1706 of the housing 1704 (e.g., attached via threaded bolts configured to extend through corresponding holes in the circuit board 1720 and engage corresponding threaded holes in the housing 1704), the first sensing area 1731 is positioned over the aperture 1752 in the insert 1750 that forms a second half of the flow channel 1708 at bend 1709, while second sensing area 1732 is positioned closer to the inlet 1710 and is not positioned over the aperture 1752. In some examples, bend 1709 directs fluid flowing in flow channel 1708 toward the first sensing area 1731, but does not direct fluid toward the second sensing area 1732. Additionally or alternatively, the aperture 1752 in the insert 1750 allows fluid in the flow channel 1708 to reach the circuit board 1720 at the first sensing area 1731 while preventing the fluid in the flow channel 1708 from reaching the circuit board 1720 at the second sensing area 1732. Thus, in some examples, fluid flowing through the flow channel 1708 will have a larger effect on the temperature of thermistors in the first sensing area 1731 compared to the second sensing area 1732.

For example, FIG. 17A shows a thermistor 1701 in a first sensing area over aperture 1752 in insert 1750 and a thermistor 1702 in a second sensing area not over aperture 1752. In some embodiments, the insert 1750 provides thermal insulation between the flow channel 1708 and thermistor 1702, but not between flow channel 1708 and thermistor 1701 due to aperture 1752.

In some examples, a protective layer is positioned between thermistors in the first sensing area 1731 (e.g., in the first pair of thermistors 1721 in the first sensing area 1731) and flow channel 1708. In some examples, the thermistors are positioned on a first surface of the circuit board 1720 such that the circuit board 1720 is between the thermistors and the flow channel 1708. In some such examples, the circuit board 1720 serves as the protective layer. In other examples, the thermistors are positioned on an inner surface of the circuit board 1720 such that the thermistors face the flow channel 1708. In some examples, an acrylic or Teflon protective layer can be positioned over the thermistors to form a protective layer between the thermistors and the flow channel 1708.

FIG. 17C shows another perspective exploded view of the OOP sensor of FIG. 17A.

In some examples, OOP sensor 1700 includes a cap 1760 configured to be coupled to the OOP sensor housing 1704, for example, by one or more bolts (e.g., via threaded bolts configured to extend through corresponding holes in the circuit board 1720 and the cap 1760 and engage corresponding threaded holes in the housing 1704). In some examples, cap 1760 is placed over the circuit board 1720 such that an inner surface of the cap 1760 faces the circuit board 1720. The inner surface of the cap 1760 can include cavities to accommodate thermistors on the circuit board. In the example of FIG. 17, cavities 1741 and 1742 can be positioned such that, when the cap 1760 is placed over the circuit board 1720, the first pair of thermistors 1721 are received in cavity 1741 and the second pair of thermistors 1722 are received in cavity 1742. Cavities can provide air gaps around the thermistors to prevent heat loss from the thermistors, for example, by conduction of heat to cap 1760 or other components of the OOP sensor 1700.

The OOP sensor 1700 further includes a standalone thermistor 1703 on the circuit board 1720 on the same side as the first pair of thermistors 1721 and second pair of thermistors 1722 and located in a third sensing area 1733. A cavity 1743 in cap 1760 can receive the standalone thermistor 1703 when the cap 1760 is placed over the circuit board 1720 and provide an air gap around the standalone thermistor 1703. The standalone thermistor 1703 can be electrically configured similar to the standalone thermistor 8 in FIG. 16.

The aperture 1752 in cap 1750 extends such that at least a portion of the third sensing area 1733 is exposed to fluid flowing through the flow channel 1708 through the aperture to allow thermal contact between the fluid and the third sensing area. In some such examples, the standalone thermistor 1703 can be used to sense the temperature of the fluid.

In some embodiments, the OOP sensor 1700 includes a heat sink 1719 positioned near the second pair of thermistors 1722 such that the heat sink 1719 affects the thermal behavior of the second pair of thermistors 1722. FIG. 17D shows an example heat sink proximate a pair of thermistors. In some examples, heat sink 1719 is placed on top of the second pair of thermistors 1722. The heat sink 1719 can stabilize the temperature of the second pair of thermistors 1722. The heat sink can include a metal foil (e.g., copper or stainless steel), and in various embodiments, the metal foil can be 0.05 mm to 0.3 mm thick and have dimensions from 1×2 mm to 5×5 mm. In some cases, the presence of heat sink 1719 increases the difference in a measurement signal between states corresponding to the flow of fluid through the flow channel 1708 and the presence of air and no fluid in the flow channel 1708 relative to an otherwise similar design without the heat sink.

FIGS. 17A-7C show an example OOP sensor 1700 having some similar features as the OOP sensor 500, including a flow channel having a bend and an insert having an aperture. One or more features of the OOP sensor 1700 of FIGS. 17A-D, such as a standalone thermistor and corresponding structure and/or a heat sink proximate the second pair of thermistors, can be included various OOP sensor designs described herein.

As described elsewhere herein, in some embodiments, temperature information (e.g., received at input 7b of ADC 7) can be used to correct a value of a measurement signal (e.g., received at input 7a of ADC 7). Temperature information can be determined using a thermistor that is part of a thermistor bridge (e.g., as shown in FIG. 2) or using a standalone thermistor (e.g., as shown in FIG. 16).

In some examples, a controller can be configured to perform a polynomial correction of a thermistor bridge reading as a function of a measured temperature. In an example embodiment, a normalized measurement signal voltage can be calculated as:

$${V}_{norm} ( t ) = {V}_{meas} ( t ) \times ( \frac{{V}_{flow} ( 25 °C )}{{V}_{flow} ( T )} )$$

where V_{flow} (T)=A₁×T⁴+A₂×T³+A₃×T²+A₄×T+A₅, Vₘₑₐₛ(t) is a raw measurement signal from the thermistor bridge, and where the values of A₁, A₂, A₃, A₄, and A₅ can be determined using a least square polynomial fit of a bridge reading to a temperature while fluid constantly flows through the OOP sensor. In an example: A₁=−1.41×10⁻⁴, A₂=1.86×10⁻², A₃=−8.89×10⁻¹, A₄=20.82, A₅=−380.

In another example, a controller can calculate a time derivative of a temperature measurement and use the time derivative to correct the bridge measurement signal as a function of the temperature. In an example embodiment a time derivative of temperature is calculated by:

$${T}^{′} ( {t}_{i}^{-} ) = \frac{{T}_{i} - {T}_{i - a}}{{t}_{i} - {t}_{i - a}}$$

where the value a can be chosen empirically to minimize noise. In an example, a=50, so that the time derivative of the temperature at a given point corresponds to a change in temperature over 50 data points. The time derivative T′ can be used to determine a correction factor A(T′). In an example, V_{corr}(t, T′)=Vₙₒᵣₘ(t)×A(T′), where A(T′)=C₁×T′+C₂.

Constants C₁, C₂ can be chosen empirically to optimize signal to noise, and in some cases, C₂ can be fixed at a predetermined value (e.g., C₂=1) and C₁ can be determined. In an example embodiment, C₂=1 and C₁=0.16. In various examples, C₁ is between 0.04 and 0.2. In some embodiments, a similar correction can be applied additionally or alternatively to a raw measurement signal Vₘₑₐₛ(t). In some such examples, corrections to the measurement signal are optimized with different constants compared to correcting the normalized signal Vₙₒᵣₘ(t).

In addition to or as an alterative to temperature correction of a measurement signal (e.g., using temperature to adjust the measurement signal measured at the thermistor bridge), other system adjustments can be made to compensate for temperature effects. For instance, in some examples, the frequency of measurement pulses (inversely related to the measuring period tₘ in FIG. 9) affects the measurement signal related to voltage measured at the thermistor bridge.

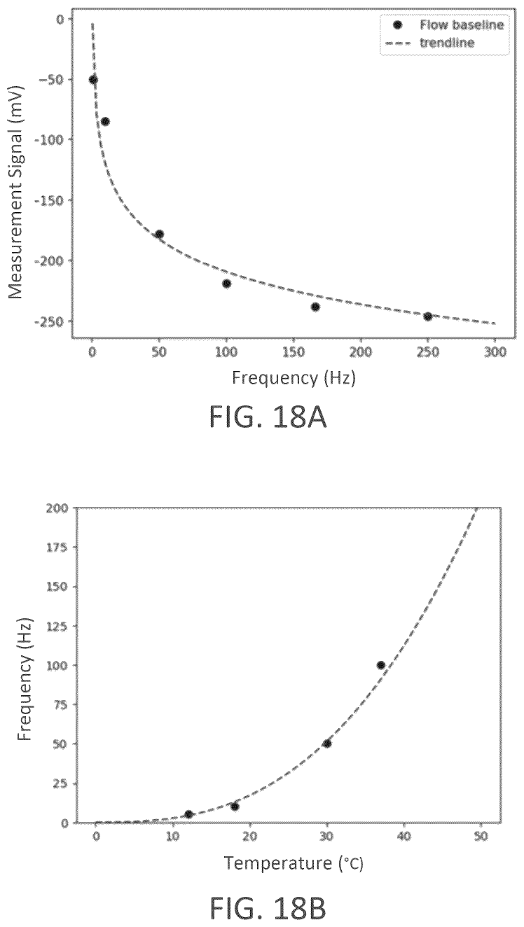

FIG. 18A shows an example plot of a measurement signal as a function of measurement frequency during a constant fluid flow through an OOP sensor. As shown, in the illustrated example, the measurement signal decreases as measurement frequency increases. FIG. 18B shows an example relationship of the measurement frequency needed to maintain a constant measurement signal as a function of temperature. As shown, as the temperature increases, the measurement frequency required to maintain a measurement signal value increases. Further, as shown in FIG. 13, in some cases, the measurement signal increases with temperature. Accordingly, in some embodiments, the measurement frequency can be adjusted based on temperature so that the effect of the temperature and the frequency on the measurement signal are at least partially negated.

A measurement frequency can be determined as a function of a measured temperature (e.g., a temperature measured at a thermistor of a thermistor bridge or a temperature measured using a standalone thermistor). In some examples, the measurement frequency increases linearly with temperature. In other examples, other functional relationships can be used, such as a power law relationship. Other mappings of temperature to a measurement frequency are possible, such as a lookup table or other relationship.

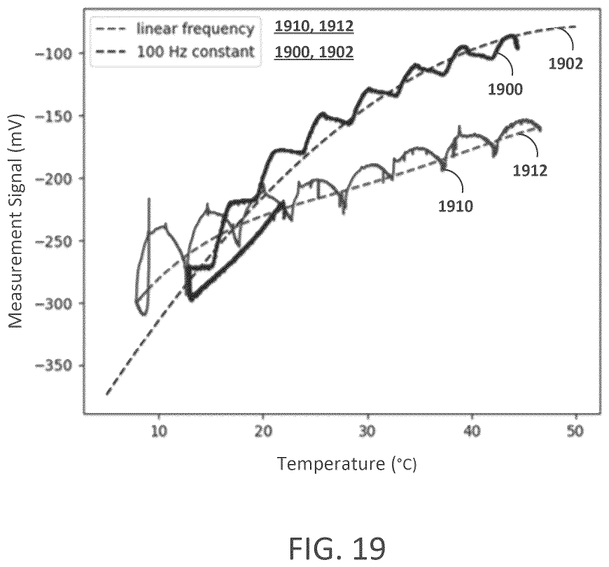

FIG. 19 shows an example measurement signal for a constant fluid flow through an OOP sensor as a function of temperature for a constant measurement frequency and a measurement frequency changing linearly with the temperature. FIG. 19 a measurement signal 1900 at different temperatures, as well as a fit line 1902 for the measurement signal, using a constant measurement frequency. FIG. 19 also shows a measurement signal 1910 at different temperatures, as well as a fit line 1912 for the measurement signal, using a measurement frequency that increases linearly with temperature. As shown the measurement signal 1910 resulting from a measurement frequency that increases with temperature is more constant at a given flow rate across the illustrated temperature range compared to the measurement signal 1900 resulting from a constant measurement frequency.

In some examples, the relationship between measurement frequency and temperature, whether via a lookup table or fit equation, can be defined empirically during a calibration. In some cases, the measurement frequency vs. temperature relationship can be calibrated for a given system prior to use.

In some examples, the controller 5 is configured to determine an average measurement signal value based on the measurement signal values received over the reading time duration, for example, by averaging a measurement signal value associated with each of the plurality of measurement pulses during the reading time duration. In some embodiments, the controller is configured to determine one average measurement signal value for each measurement cycle, e.g., as shown in FIG. 9. In some examples, the controller is configured to determine, based on the average measurement signal value, a flow status through the flow channel.

In some embodiments, determining the flow status through the flow channel comprises comparing the average measurement signal value to one or more predetermined threshold conditions. In some examples, determining the flow status comprises if the average measurement signal value satisfies a first predetermined threshold condition (e.g., being below a predetermined threshold value), determining that fluid is flowing in the flow channel. Additionally or alternatively, in some examples, determining the flow status comprises if the average measurement signal value satisfies a second predetermined threshold condition (e.g., being above a second predetermined threshold value), determining that fluid is not present in the flow channel. In some further embodiments, determining the flow status within the flow channel further comprises, if the average measurement signal value is between the first predetermined threshold value and the second predetermined threshold value, determining that fluid is present, but not flowing, in the flow channel.

In some examples, thermistors are negative temperature coefficient (NTC) thermistors such that the resistance of the thermistor decreases with increasing temperature. With reference to FIGS. 2 and 9, if thermistors 1a and 1b are in a first sensing area more affected by fluid in a flow channel compared to thermistors 2a and 2b in a second sensing area, after heating the thermistors during an excitation time (t_{E} in FIG. 9) and allowing the thermistors to rest during a delay time (tₚ) in FIG. 9, thermistors 1a and 1b may be cooled by fluid in the flow channel more than thermistors 2a and 2b, since the temperature of thermistors 1a and 1b may be more affected by the fluid in the flow channel compared to thermistors 2a and 2b. If thermistors 1a and 1b are cooler than thermistors 2a and 2b, and such thermistors are NTC thermistors, the resistance of thermistors 1a and 1b will be higher than the resistance of thermistors 2a and 2b. In some such examples, the voltage drop across thermistor 1a will be greater than the voltage drop across thermistor 2a, and the voltage at point 11 will be higher than the voltage at point 12. In some examples, the larger the temperature difference between thermistors 1a,b and thermistors 2a,b, the larger the difference in voltage at points 11 and 12. In some examples, a higher voltage at point 11 compared to the voltage at point 12 results in a negative voltage at first input 7a of ADC 7. In some cases, the more the temperature of thermistors 1a,b is below the temperature of thermistors 2a,b, the more negative the voltage at first input 7a of ADC 7.

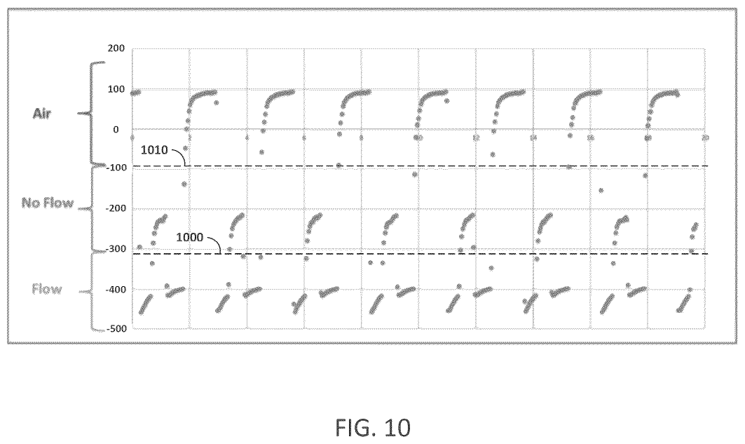

FIG. 10 shows an example plot of average measurement signal values over time. In the illustrated example, the plot shows a voltage over time (e.g., in mV vs. seconds), though other data is possible, such as temperature information. In the example of FIG. 10, the plot shows a first predetermined threshold value 1000 and a second predetermined threshold value 1010. As described elsewhere herein, in some embodiments, if the average measurement signal value satisfies a first predetermined threshold condition, the controller determines that a fluid is flowing in the flow channel (e.g., a liquid from a product reservoir), and if the average measurement signal value satisfies a second predetermined threshold condition, the controller determines that a fluid (e.g., liquid from the product reservoir) is not present in the flow channel. With reference to FIG. 10, in some examples, the average measurement signal value satisfying the first predetermined threshold condition comprises the average measurement signal value being below the first predetermined threshold value 1000. In some examples, the average measurement signal value satisfying the second predetermined threshold condition comprises the average measurement signal value being above the second predetermined threshold value 1010, the second predetermined threshold value being higher than the first.

For instance, in some examples, as described herein, thermistors comprise NTC thermistors, and fluid in the flow channel can cause thermistors in the first sensing area to have a lower temperature and higher resistance compared to thermistors in the second sensing area, causing a negative voltage sensed at ADC 7. In some examples, flowing fluid lowers the temperature of the thermistors in the first sensing area more quickly and/or to a greater degree than stagnant fluid that is present, but not flowing, in the flow channel. However, stagnant fluid can still lower the temperature of thermistors in the first sensing area more quickly and/or to a greater degree than thermistors in the second sensing area. Thus, in some examples, determining the flow status within the flow channel further comprises, if the average measurement signal value is between the first predetermined threshold value 1000 and the second predetermined threshold value 1010, determining that fluid is present, but not flowing, in the flow channel.

With reference to FIG. 10, in some examples, data points representing an average measurement value below the first predetermined threshold value 1000 correspond to points in time during which a fluid is flowing in the flow channel. Data points representing an average measurement value above the second predetermined threshold value 1010 correspond to points in time in which a fluid is not present in the flow channel. Data points representing an average measurement value between the first predetermined threshold value 1000 and the second predetermined threshold value 1010 correspond to points in time during which a fluid is present, but not flowing, in the flow channel.

In some examples, the fluid corresponds to a liquid, such as from a product reservoir, such that the fluid being present and/or flowing in the flow channel corresponds to a liquid in the flow channel, and the fluid being not present in the flow channel corresponds to the liquid not being present in the flow channel. For instance, in some cases, the absence of the liquid corresponds to the flow channel having only air and no liquid therein.

In some examples, an OOP sensing system can include a user interface in communication with the controller. In an example embodiment, an interface comprises two lights and the controller is configured to illuminate a first light if fluid is flowing through the flow channel and the second light if fluid is not flowing in the flow channel. In various embodiments, either light can be used to indicate fluid is present, but not flowing, in the flow channel. In some examples, a system includes a third light wherein the controller can illuminate the first light (e.g., a green light) if fluid is flowing through the flow channel, the second light (e.g., a red line) if fluid is not present in the flow channel, and the third light (e.g., a yellow light) if fluid is present, but not flowing, in the flow channel. Other indications can be used, such as an illuminated solid light, a blinking light, and an off light.

Additionally or alternatively, in some embodiments, a user interface includes a graphical display screen configured to output a textual message indicating a flow status to a user and/or one or more speakers configured to output sounds indicating a flow status to a user.

In some examples, thermistors and, for example, ADC 7 and/or controller 5 are configured such that fluid flowing through the flow channel of the OOP sensor causes the signal of FIG. 10 to go more negative. However, in other configurations, fluid flowing through the flow channel can cause a signal to go more positive, for example, by measuring an opposite polarity at the ADC. In some examples, positive temperature coefficient thermistors can be used, which can change the behavior of the thermistors when experiencing different temperatures due to fluid flowing in the flow channel.

Accordingly, in some examples, a signal being above a first predetermined threshold can correspond to fluid flowing in a flow channel, a signal being below a second predetermined threshold can correspond to an absence of fluid within the flow channel.

In some examples, a controller (e.g., controller 5 in FIG. 2) is configured to determine an operational status of a pump (e.g., pump 102 in FIG. 1). The controller can be configured to use pump status information to determine a fluid flow status through the OOP sensor. In some examples, the OOP sensor only provides an output indicating a fluid flow status when the pump is operational. In some examples, if the controller determines that the pump is on and that no fluid is flowing in the OOP sensor, the controller can be configured to provide an output an indication of an out of product event, for example, via a user interface. An out of product event, for example, indicated by an absence of a fluid (e.g., an absence of a liquid product from a product reservoir) can indicate that a source of the fluid (e.g., a reservoir) is depleted. In some embodiments, the controller can be programmed with one or more additional

thresholds, such as a threshold amount of time for the pump to be operational before indicating an out of product event. For instance, in some embodiments, for a liquid product that releases a gas and that is to be pumped from a reservoir through an OOP sensor, initial pumping might result in gas released from the liquid being pumped through the corresponding line before the liquid flows therethrough. Accordingly, the OOP sensor might not sense the presence of liquid until some amount of time after the pump is activated. In some embodiments, a predetermined amount of time is required between pump activation and indicating an out of product event in order to reduce false detections of out of product events. The predetermined amount of time can be calibrated based on, for example, the system configuration, liquid product properties, and/or other system properties.

Other predetermined thresholds can be calibrated for a given system, including, for example, the first and second predetermined thresholds corresponding to detecting the presence or absence of fluid. Additionally or alternatively, in some embodiments, a measurement signal from the OOP sensor can be analyzed to provide additional information about the system. For instance, a measurement signal can provide information representative of poor pump operation, broken tubing, bubbles present in the line, or other flow system characteristics. In some embodiments, a controller can be configured to analyze the measurement signal in order to detect one or more such occurrences.

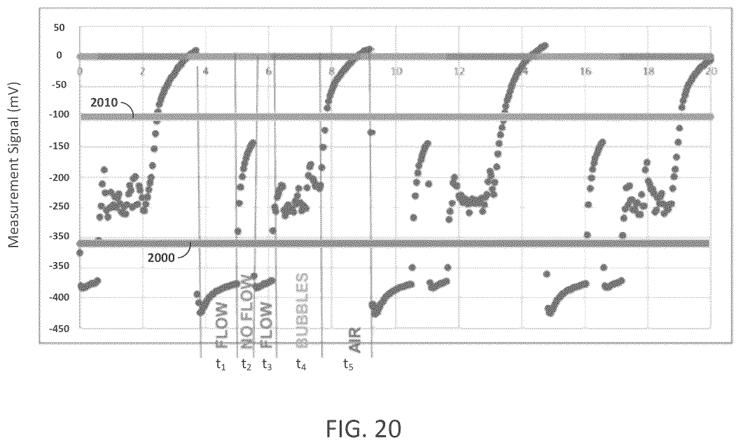

FIG. 20 shows an example plot of a measurement signal over time that can be used to detect bubbles in the OOP sensor. As shown in the illustrated example, in some embodiments, when a measurement signal is below a first predetermined threshold value 2000, the controller can determine that fluid is flowing in the flow channel, such as during time periods t₁ and t₃ of FIG. 20. When a measurement signal is above a second predetermined threshold value 2010, the controller can determine that no fluid is in the flow channel, such as in time period t₅. When the measurement signal is between the first predetermined threshold value 2000 and the second predetermined threshold value 2010, the measurement signal can be analyzed to determine further information about the flow status. For instance, the measurement signal pattern in time period t₂ can be representative of fluid present, but not flowing in the flow channel, while the measurement signal pattern in time period t₄ can be indicative of a fluid with bubbles flowing through flow channel. The controller can be configured to recognize patterns in the measurement signal and output information regarding the flow status, such as the presence of bubbles in the flow channel.

In some embodiments, the OOP sensor provides a greatest temperature difference between the first sensing area and second sensing area, and a greater distinction between average measurement values associated with flowing fluid and an absence of fluid, when OOP sensor is arranged in certain orientations. For instance, in some cases, such a temperature difference is maximized when fluid flows vertically upward through a flow channel. Accordingly, in some cases, during operation, an OOP sensor is arranged such that fluid flows vertically through the flow channel and so that fluid flows upward therethrough. In some examples, deviating by approximately 15 degrees from a vertical flow direction results in substantially similar performance as when oriented vertically.

In some examples, various orientations are possible. For instance, in some examples, temperature differences between the first sensing area and second sensing area create detectable distinctions between flow states (e.g., fluid flowing through the flow channel and an absence of fluid within the flow channel) when oriented horizontally or facing another direction. In general, various embodiments, can be used in a variety of orientations.

Various illustrative examples have been described. These and others are within the scope of this disclosure.

1. An out of product (OOP) sensing system comprising:
a housing comprising a first surface and defining a flow channel;
an inlet fluidly connecting the flow channel of the housing to an exterior of the housing;
an outlet fluidly connecting the flow channel of the housing to the exterior of the housing;
a circuit board coupled to the first surface of the housing;
a thermistor bridge supported by the circuit board and comprising a plurality of thermistors, the thermistor bridge comprising a first branch having a first thermistor in series with a second thermistor and a first point between the first thermistor and the second thermistor and a second branch having a third thermistor in series with a fourth thermistor and a second point between the third thermistor and the fourth thermistor, the first branch and the second branch being arranged in parallel between a powered side of the thermistor bridge and a reference side of the thermistor bridge such that the first thermistor and the third thermistor are coupled to the powered side of the thermistor bridge and the second thermistor and the fourth thermistor are coupled to the reference side of the thermistor bridge;
a power supply;
a switch coupled to the power supply; and
a controller in communication with the switch and configured to control operation of the switch to selectively permit current to flow from the power supply to the thermistor bridge via the switch; and wherein
the first thermistor and the fourth thermistor are located in a first sensing area and form a first pair of thermistors;
the second thermistor and the third thermistor are located in a second sensing area, different from the first sensing area, and form a second pair of thermistors;
the housing is configured such that:
(i) thermal resistance between the flow channel and the first sensing area is lower than thermal resistance between the flow channel and the second sensing area, and/or
(ii) fluid flowing in the flow channel is directed more toward the first sensing area than the second sensing area; and
the controller is configured to:
place the switch into an on state to cause current to flow from the power supply to the thermistor bridge for a heating time duration;
place the switch into an off state to stop current from flowing to the thermistor bridge at the end of the heating time duration;
maintain the switch in the off state for a delay time duration;
after the end of the delay time duration and during a reading time duration, provide a plurality of measurement pulses, each of the measurement pulses having a measurement pulse time duration, and the plurality of measurement pulses being provided at a measurement frequency;
during each of the plurality of measurement pulses, receive a measurement signal value representative of a voltage between the first point on the first branch of the thermistor bridge and the second point on the second branch of the thermistor bridge;
determine an average measurement signal value based on the measurement signal values received over the reading time duration; and
determine, based on the average measurement signal value, a flow status through the flow channel.

2. The OOP sensing system of claim 1, wherein:
the flow channel comprises a cylindrical channel;
the first surface of the housing comprises a first area and a second area, the housing being thinner in the first area compared to the second area;
the circuit board is coupled to the first surface of the housing so that:
the first sensing area is positioned over the first area of the first surface so that the first area of the first surface separates the first pair of thermistors from the flow channel; and
the second sensing area is positioned over the second area of the first surface so that the second area of the first surface separates the second pair of thermistors from the flow channel.

3. The OOP sensing system of claim 1, wherein:
the flow channel comprises a cylindrical channel; and
the circuit board is curved so that the first sensing area closer to the flow channel than the second sensing area.

4. The OOP sensing system of claim 1, wherein:
the first surface comprises an aperture extending through the first surface; and
the circuit board is coupled to the first surface of the housing so that:
the first sensing area is positioned over the aperture extending through the first surface so that the first surface does not separate the first pair of thermistors from the flow channel; and
the second sensing area is positioned on the circuit board in a position that is not over the aperture extending through the first surface such that the first surface separates the second pair of thermistors from the flow channel.

5. The OOP sensing system of claim 4, further comprising a protective layer positioned between the first pair of thermistors and the flow channel such that the protective layer is exposed to the flow channel through the aperture extending through the first surface.

6. The OOP sensing system of claim 5, wherein the protective layer comprises acrylic or Teflon.

7. The OOP sensing system of claim 5, wherein the protective layer comprises the circuit board.

8. The OOP sensing system of claim 7, wherein the circuit board has a thickness of between approximately 0.025 mm and 0.2 mm.

9. The OOP sensing system of claim 7, wherein the circuit board comprises glass epoxy laminate FR-4 or polyimide.

10. The OOP sensing system of claim 4, further comprising an insert configured to be inserted into the aperture in the first surface and comprising an aperture extending through the insert, and wherein the circuit board, the first surface of the housing, and insert are arranged such that the first pair of thermistors is positioned over the aperture extending through the first surface of the housing and over the aperture extending through the insert so that neither the first surface of the housing nor the insert separate the first pair of thermistors from the flow channel.

11. The OOP sensing system of claim 10, wherein the flow channel defined by the housing comprises a first half of a tubular flow channel, and wherein the insert comprises an inner surface defining second half of a tubular flow channel and is configured such that, when the insert is inserted into the aperture in the first surface, the flow channel defined by the housing and the inner surface of the insert join to form a closed tubular flow channel.

12. The OOP sensing system of claim 11, wherein the closed tubular flow channel comprises a bend in the tubular flow channel toward the first surface of the housing.

13. The OOP sensing system of claim 1, further comprising a flow obstruction positioned in the flow channel, the flow obstruction being configured to direct fluid flowing through the flow channel toward the first surface of the housing.

14. The OOP sensing system of claim 1, wherein the flow channel comprises a bend in the flow channel toward the first surface of the housing.

15. The OOP sensing system of claim 1, wherein determining the flow status within the flow channel comprises:
if the average measurement signal value satisfies a first predetermined threshold condition, determining that a fluid is flowing in the flow channel; and
if the average measurement signal value satisfies a second predetermined threshold condition, determining that a fluid is not present in the flow channel.

16. The OOP sensing system of claim 15, wherein:
the average measurement signal value satisfying the first predetermined threshold condition comprises the average measurement signal value being below a first predetermined threshold value; and
the average measurement signal value satisfying the second predetermined threshold condition comprises the average measurement signal value being above a second predetermined threshold value, the second predetermined threshold value being higher than the first.

17. The OOP sensing system of claim 16, wherein determining the flow status within the flow channel further comprises, if the average measurement signal value is between the first predetermined threshold value and the second predetermined threshold value, determining that a fluid is present, but not flowing, in the flow channel.

18. The OOP sensing system of claim 1, wherein each of the plurality of thermistors comprise negative temperature coefficient (NTC) thermistors.

19. The OOP sensing system of claim 1, further comprising an analog to digital converter (ADC) in communication with the first point of the thermistor bridge and the second point of the thermistor bridge, and wherein the controller is configured to receive the measurement signal value from the ADC.

20. The OOP sensing system of claim 1, further comprising a current limiting resistor connected between the switch and the powered side of the thermistor bridge such that, when the switch is closed, current flows from the power supply through the switch and through the current limiting resistor to the powered side of the thermistor bridge.

21. The OOP sensing system of claim 1, wherein the power supply comprises a 5 volt power supply.

22. The OOP sensing system of claim 1, wherein the housing is oriented so that fluid flows vertically upward through the flow channel.

23. The OOP sensing system of claim 1, wherein the controller is configured to:
receive a second signal representative of a voltage drop across one of the plurality of thermistors; and
for each received measurement signal value, calculate a corrected measurement signal value based on the received second signal; and wherein
determining the average measurement signal value based on the measurement signal values received over the reading time duration comprises averaging the corrected measurement signal values over the reading time duration.

24. The OOP sensing system of claim 23, wherein the second signal is representative of a voltage drop across the second thermistor.

25. The OOP sensing system of claim 23, wherein calculating the corrected measurement signal value comprises multiplying the measurement signal value by a correction coefficient, wherein the correction coefficient comprises a fourth-order polynomial of the second signal.

26. The OOP sensing system of claim 1, further comprising a standalone thermistor supported by the circuit board and separate from the first thermistor, second thermistor, third thermistor, and fourth thermistor, and wherein the controller is configured to:
receive a second signal representative of a voltage drop across the standalone thermistors; and
for each received measurement signal value, calculate a corrected measurement signal value based on the received second signal; and wherein
determining the average measurement signal value based on the measurement signal values received over the reading time duration comprises averaging the corrected measurement signal values over the reading time duration.

27. The OOP sensing system of claim 26, wherein the controller is further configured to calculate a temperature based on the second signal.

28. The OOP sensor of claim 27, wherein the controller is configured to calculate the corrected measurement signal values based on the calculated temperature.

29. The OOP sensor of claim 28, wherein the controller is configured to calculate the corrected measurement signal values using a time derivative of the calculated temperature.

30. The OOP sensor of claim 28, wherein the controller is configured to determine the measurement frequency based on the calculated temperature.
